(19) United States
(12) Patent Application Publication
(10) Pub. No.: US 2015/0036744 A1
(43) Pub. Date: Feb. 5, 2015

(54) IMAGE PROCESSING APPARATUS AND IMAGE PROCESSING METHOD

(71) Applicant: Sony Corporation, Tokyo (JP)

(72) Inventor: Kazushi SATO, Kanagawa (JP)

(73) Assignee: Sony Corporation, Tokyo (JP)

(21) Appl. No.: 14/378,765

(22) PCT Filed: Mar. 5, 2013
(86) PCT No.: PCT/JP2013/055978

§ 371 Date: Aug. 14, 2014

(30) Foreign Application Priority Data
May 2, 2012 (JP) 2012-105245

(51) Int. Cl. H04N 19/51; H04N 19/182; H04N 19/186; H04N 19/187

(52) U.S. Cl. CPC H04N 19/00587; H04N 19/00321; H04N 19/00303; H04N 19/00315
USPC 375/240.12

(57) ABSTRACT

Provided is an image processing apparatus including an enhancement layer prediction section configured to generate a predicted image of a first prediction block of a color difference component in an enhancement layer of an image subjected to scalable video decoding using a prediction function of a luminance based color difference prediction mode having coefficients calculated from a luminance component and the color difference component in a position corresponding to the first prediction block in a base layer.

### TECHNICAL FIELD

The present disclosure relates to an image processing apparatus and an image processing method.

### BACKGROUND ART

The standardization of an image coding scheme called HEVC (High Efficiency Video Coding) by JCTVC (Joint Collaboration Team-Video Coding), which is a joint standardization organization of ITU-T and ISO/IEC, is currently under way for the purpose of improving coding efficiency more than H.264/AVC. For the HEVC standard. Committee draft as the first draft specifications was issued in February, 2012 (see, for example, Non-Patent Literature 1 below).

One important technology in image coding schemes including HEVC is an intra-screen prediction, that is, an intra prediction. The intra prediction is a technology that reduces the amount of information to be coded by using various correlation characteristics of an image and predicting a pixel value in some block from pixel values of other blocks. For the intra prediction, the optimum prediction mode to predict pixel values of blocks to be predicted is normally selected from a plurality of prediction modes. In HEVC, for example, various prediction modes such as the DC prediction, the angular prediction, and the planar prediction can be selected. For the intra prediction of a color difference component, an additional prediction mode called a linear model (LM) mode that predicts the pixel value of a color difference component using a dynamically constructed linear function of a luminance component as a prediction function is also proposed (see Non-Patent Literature 2 below).

Incidentally, scalable video coding (SVC) is one of important technologies for future image coding schemes. The scalable video coding is a technology that hierarchically encodes a layer transmitting a rough image signal and a layer transmitting a fine image signal. Typical attributes hierarchized in the scalable video coding mainly include the following three:
Space scalability: Spatial resolutions or image sizes are hierarchized.
Time scalability: Frame rates are hierarchized.
SNR (Signal to Noise Ratio) scalability: SN ratios are hierarchized.

Further, though not yet adopted in the standard, the bit depth scalability and chroma format scalability are also discussed. Also, encoding a base layer in scalable video coding by a conventional image coding scheme and encoding an enhancement layer by HEVC is also proposed (see Non-Patent Literature 3 below).

### CITATION LIST

### Non-Patent Literature

Non-Patent Literature 1: Benjamin Bross, Woo-Jin Han, Jens-Rainer Ohm, Gary J. Sullivan, Thomas Wiegand, “High efficiency video coding (HEVC) text specification draft 6” (JCTVC-H 1003 ver20, Feb. 17, 2012)
Non-Patent Literature 2: Jianle Chen, et al. “CE6.a.4: Chroma intra prediction by reconstructed luma samples” (JCTVC-E266, March, 2011)
Non-Patent Literature 3: Ajay Luthra, Jens-Rainer Ohm. Joern Ostermann, “Draft requirements for the scalable enhancement of HEVC” (ISO/IEC JTC1/SC29/WG11 N12400, November, 2011)

### SUMMARY OF INVENTION

### Technical Problem

In LM mode proposed by Non-Patent Literature 2 described above, coefficients of a prediction function are calculated by using pixel values of the luminance component and the color difference component of neighboring blocks adjacent to the block to be predicted. Thus, if the correlation between color components in the block to be predicted is different from that in neighboring blocks, a prediction function having good prediction precision will not be constructed. As a result, the LM mode is useful only if the correlation between color components is sufficiently similar between the block to be predicted and neighboring blocks.

When, in a single-layer (or single-view) image coding scheme, the color difference component of some block is predicted, normally the actual pixel value of the color difference component is naturally unknown. In a multilayer (or multi-view) image coding scheme, however, when the color difference component of some block is predicted, there may be a case when the actual pixel value of the color difference component of the corresponding layer in another layer is already decoded.

In this specification, the above point is focused on and technology to improve prediction precision in LM mode for an intra prediction of the color difference component mainly in scalable video coding is proposed.

### Solution to Problem

According to the present disclosure, there is provided an image processing apparatus including an enhancement layer prediction section configured to generate a predicted image of a first prediction block of a color difference component in an enhancement layer of an image subjected to scalable video decoding using a prediction function of a luminance based color difference prediction mode having coefficients calculated from a luminance component and the color difference component in a position corresponding to the first prediction block in a base layer.

The image processing apparatus mentioned above may be typically realized as an image decoding device that decodes an image.

According to the present disclosure, there is provided an image processing method including generating a predicted image of a first prediction block of a color difference component in an enhancement layer of an image subjected to scalable video decoding using a prediction function of a luminance based color difference prediction mode having coefficients calculated from a luminance component and the color difference component in a position corresponding to the first prediction block in a base layer.

According to the present disclosure, there is provided an image processing apparatus including an enhancement layer prediction section configured to generate a predicted image of a first prediction block of a color difference component in an enhancement layer of an image subjected to scalable video coding using a prediction function of a luminance based color difference prediction mode having coefficients calculated from a luminance component and the color difference component in a position corresponding to the first prediction block in a base layer.

The image processing apparatus mentioned above may be typically realized as an image encoding device that encodes an image.

According to the present disclosure, there is provided an image processing method including generating a predicted image of a first prediction block of a color difference component in an enhancement layer of an image subjected to scalable video coding using a prediction function of a luminance based color difference prediction mode having coefficients calculated from a luminance component and the color difference component in a position corresponding to the first prediction block in a base layer.

### Advantageous Effects of Invention

According to technology in the present disclosure, prediction precision in LM mode for an intra prediction of the color difference component can be improved.

### BRIEF DESCRIPTION OF DRAWINGS

FIG. 1 is an explanatory view illustrating scalable video coding.

FIG. 2 is an explanatory view illustrating an existing LM mode.

FIG. 3 is an explanatory view illustrating a new LM mode proposed in the present disclosure.

FIG. 4 is a block diagram showing a schematic configuration of an image encoding device according to an embodiment.

FIG. 5 is a block diagram showing a schematic configuration of an image decoding device according to an embodiment.

FIG. 6 is a block diagram showing an example of the configuration of a first encoding section and a second encoding section shown in FIG. 4.

FIG. 7 is a block diagram showing an example of a detailed configuration of an intra prediction section shown in FIG. 6.

FIG. 8 is an explanatory view illustrating an example of thinning out reference pixels.

FIG. 8 is a flow chart showing an example of a schematic process flow for encoding according to an embodiment.

FIG. 10 is a flow chart showing an example of a detailed flow of an intra prediction process of an enhancement layer shown in FIG. 9.

FIG. 11 is a block diagram showing an example of the configuration of a first decoding section and a second decoding section shown in FIG. 5.

FIG. 12 is a block diagram showing an example of the detailed configuration of an intra prediction section shown in FIG. 11.

FIG. 13 is a flow chart showing an example of the schematic process flow for decoding according to an embodiment.

FIG. 14 is a flow chart showing an example of the detailed flow of the intra prediction process of the enhancement layer shown in FIG. 13.

FIG. 15 is a block diagram showing an example of a schematic configuration of a television.

FIG. 16 is a block diagram showing an example of a schematic configuration of a mobile phone.

FIG. 17 is a block diagram showing an example of a schematic configuration of a recording/reproduction device.

FIG. 18 is a block diagram showing an example of a schematic configuration of an image capturing device.

FIG. 19 is an explanatory view illustrating a first example of use of the scalable video coding.

FIG. 20 is an explanatory view illustrating a second example of use of the scalable video coding.

FIG. 21 is an explanatory view illustrating a third example of use of the scalable video coding.

FIG. 22 is an explanatory view illustrating a multi-view codec.

FIG. 23 is a block diagram showing a schematic configuration of the image encoding device for multi-view codec.

FIG. 24 is a block diagram showing a schematic configuration of the image decoding device for multi-view codec.

### DESCRIPTION OF EMBODIMENTS

Hereinafter, preferred embodiments of the present disclosure will be described in detail below with reference to the drawings. Note that, in this specification and the drawings, elements that have substantially the same function and structure are denoted with the same reference signs, and repeated explanation is omitted.

The description will be provided in the order shown below:

1. Overview

1-1. Scalable Video Coding

1-2. Existing LM Mode

1-3. New LM mode

1-4. Basic Configuration Example of Encoder

1-5. Basic Configuration Example of Decoder

2. Configuration Example of Encoding Section According to an Embodiment

2-1. Overall Configuration

2-2. Detailed Configuration of Intra Prediction Section

3. Process Flow for Encoding According to an Embodiment

4. Configuration Example of Decoding Section According to an Embodiment

4-1. Overall Configuration

4-2. Detailed Configuration of Intra Prediction Section

5. Process Flow for Decoding According to an Embodiment

6. Application Examples

6-1. Application to Various Products

6-2. Various Uses of Scalable Video Coding

6-3. Others

7. Summary

### 1. OVERVIEW

### 1-1. Scalable Video Coding

In the scalable video coding, a plurality of layers, each containing a series of images, is encoded. A base layer is a layer encoded first to represent roughest images. An encoded stream of the base layer may be independently decoded without decoding encoded streams of other layers. Layers other than the base layer are layers called enhancement layer representing finer images. Encoded streams of enhancement layers are encoded by using information contained in the encoded stream of the base layer. Therefore, to reproduce an image of an enhancement layer, encoded streams of both of the base layer and the enhancement layer are decoded. The number of layers handled in the scalable video coding may be any number equal to 2 or greater. When three layers or more are encoded, the lowest layer is the base layer and the remaining layers are enhancement layers. For an encoded stream of a higher enhancement layer, information contained in encoded streams of a lower enhancement layer and the base layer may be used for encoding and decoding. In this specification, of at least two layers having dependence, the layer on the side depended on is called a lower layer and the layer on the depending side is called an upper layer.

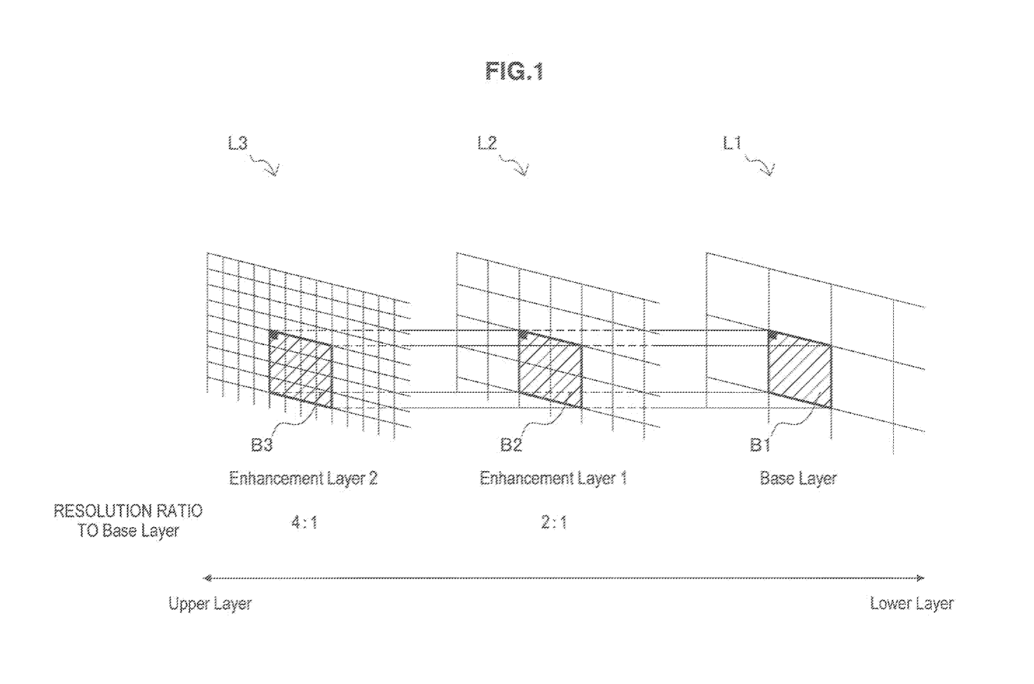

FIG. 1 shows three layers L1, L2, L3 subjected to scalable video coding. The layer L1 is the base layer and the layers L2, L3 are enhancement layers. Here, among various kinds of scalability, the space scalability is taken as an example. The ratio of spatial resolution of the layer L2 to the layer L1 is 2:1. The ratio of spatial resolution of the layer L3 to the layer L1 is 4:1. However, the scalability ratio is not limited to such examples. For example, the scalability ratio of a non-integer like 1.5:1 may be adopted. A block B1 of the layer L1 is a prediction block inside a picture of the base layer. A block B2 of the layer L2 is a prediction block inside a picture of an enhancement layer taking a scene common to the block B1. The block B2 corresponds to the block B1 of the layer L1. A block B3 of the layer L3 is a prediction block inside a picture of a higher enhancement layer taking a scene common to the blocks B1 and B2. The block B3 corresponds to the block B1 of the layer L1 and the block B2 of the layer L2.

In such a layer structure, correlation characteristics of an image of some layer are normally similar to correlation characteristics of the image of other layers corresponding to a common scene. Correlation characteristics may include spatial correlations, temporal correlations, and correlations between color components. Taking spatial correlations as an example, if, for example, the block B1 has a strong correlation with a neighboring block in some direction in the layer L1, it is likely that the block B2 has a strong correlation with a neighboring block in the same direction in the layer L2 and the block B3 has a strong correlation with a neighboring block in the same direction in the layer L3. Therefore, when, for example, a specific prediction mode is determined to be optimum for some block in the base layer, the same prediction mode is also likely to be optimum for the corresponding block in an enhancement layer. This trend can motivate the reuse of prediction mode information between layers. That correlation characteristics of an image are similar between layers applies not only to space scalability illustrated in FIG. 1, but also to SNR scalability, bit depth scalability, and chroma format scalability.

The LM mode (also called the luminance based color difference prediction mode) proposed in Non-Patent Literature 2 is a prediction mode that attempts to predict a pixel value of the color difference component from a pixel value of the luminance component by using correlations between the luminance component and the color difference component. The prediction is made by using a prediction function having coefficients calculated by using pixel values of the luminance component and the color difference component of neighboring blocks. However, correlations between color components are not necessarily similar between the prediction block and neighboring blocks. Then, if correlations between color components are not similar, a prediction function constructed based on pixel values of neighboring blocks no longer has good prediction precision to predict a pixel value of the color difference component of the prediction block. For the above reason, the LM mode has been useful only in relatively limited cases.

In a multi-layer (or multi-view) image coding scheme as described using FIG. 1, however, when, for example, an intra prediction is about to be made for a prediction block in an enhancement layer, the corresponding block in a lower layer is already encoded or decoded. Then, even if correlations between color components are not similar between the prediction block and neighboring blocks, correlations between color components are equivalent or at least similar between the prediction block and the corresponding block in a lower layer. Therefore, by constructing a prediction function in LM mode based on, instead of neighboring blocks, pixel values of the corresponding block in a lower layer, it is expected that higher prediction precision than that of the existing LM mode can be achieved in an enhancement layer. In technology according to the present disclosure, prediction precision improved more than the existing technique is realized by modifying the LM mode of intra prediction of the color difference component in scalable video coding.

### 1-2. Existing LM Mode

In the LM mode (luminance based color difference prediction mode) proposed in the standardization work of HEVC, a linear function having dynamically calculated coefficients is used as a prediction function. Arguments of a prediction function are values of luminance components (down-sampled when necessary) and the return value thereof is a predicted pixel value of the color difference component. More specifically, the prediction function in LM mode may be a linear function as shown below:

[Math. 1]

Pr_{C}[x,y]=α·Re_{L}′[x,y]+β (1)

In Formula (1), Re_{L}′(x, y) represents a down-sampled value of the luminance component of a decoded image (so-called reconstructed image). Down-sampling (or phase shifting) of the luminance component may be performed when the density of the color difference component is different from that of the luminance component depending on the chroma format. α and β are coefficients calculated from pixel values of neighboring blocks using a predetermined formula.

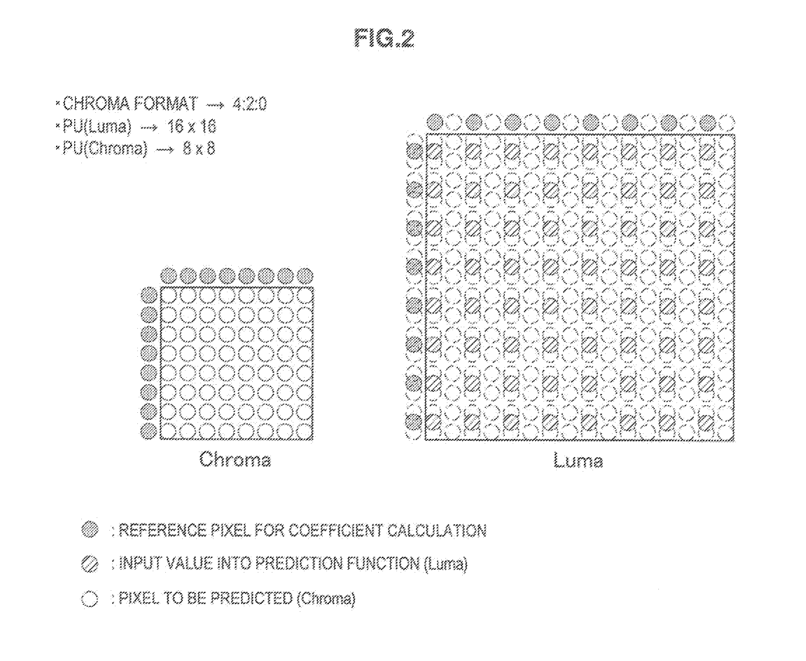

Referring to, for example. FIG. 2, the prediction block of the luminance component (Luma) having the size of 16×16 pixels and the prediction block of the corresponding color difference component (Chroma) when the chroma format is 4:2:0 are conceptually shown. The density of the luminance component is twice that of the color difference component for each of the horizontal direction and the vertical direction. Circles positioned around each prediction block and filled in in FIG. 2 are reference pixels in neighboring blocks referred to when the coefficients α, β of the prediction function are calculated. Circles diagonally shaded on the right in FIG. 2 are down-sampled luminance components in the prediction block to be processed. By substituting values of down-sampled luminance components as described above into the right side Re_{L}′(x, y) of the prediction function, the predicted value of the color difference component in a common pixel position is calculated. When the chroma format is 4:2:0, like the example in FIG. 2, an input value (value substituted into the prediction function) of one luminance component is generated by down-sampling for each (2×2) luminance components. Reference pixels can also be down-sampled in the same manner.

The coefficients α and β of the prediction function are calculated according to Formula (2) and Formula (3) respectively. I represents the number of reference pixels.

$$\begin{matrix}[ Math . 2 ] & \\ α = \frac{I \cdot {\sum }_{i = 0}^{I} {Re}_{C} ( i ) \cdot {Re}_{L}^{′} ( i ) - {\sum }_{i = 0}^{I} {Re}_{C} ( i ) \cdot {\sum }_{i = 0}^{I} {Re}_{L}^{′} ( i )}{I \cdot {\sum }_{i = 0}^{I} {Re}_{L}^{′} ( i ) \cdot {Re}_{L}^{′} ( i ) - {( {\sum }_{i = 0}^{I} {Re}_{L}^{′} ( i ) )}^{2}} & ( 2 ) \\ β = \frac{{\sum }_{i = 0}^{I} {Re}_{C} ( i ) - α \cdot {\sum }_{i = 0}^{I} {Re}_{L}^{′} ( i )}{I} & ( 3 )\end{matrix}$$

In the technology according to the present disclosure, the technique dependent on neighboring blocks to construct a prediction function in LM mode is modified, as will be described next, into a technique dependent on, instead of neighboring blocks, the corresponding block in a lower layer particularly in an enhancement layer.

### 1-3. New LM Mode

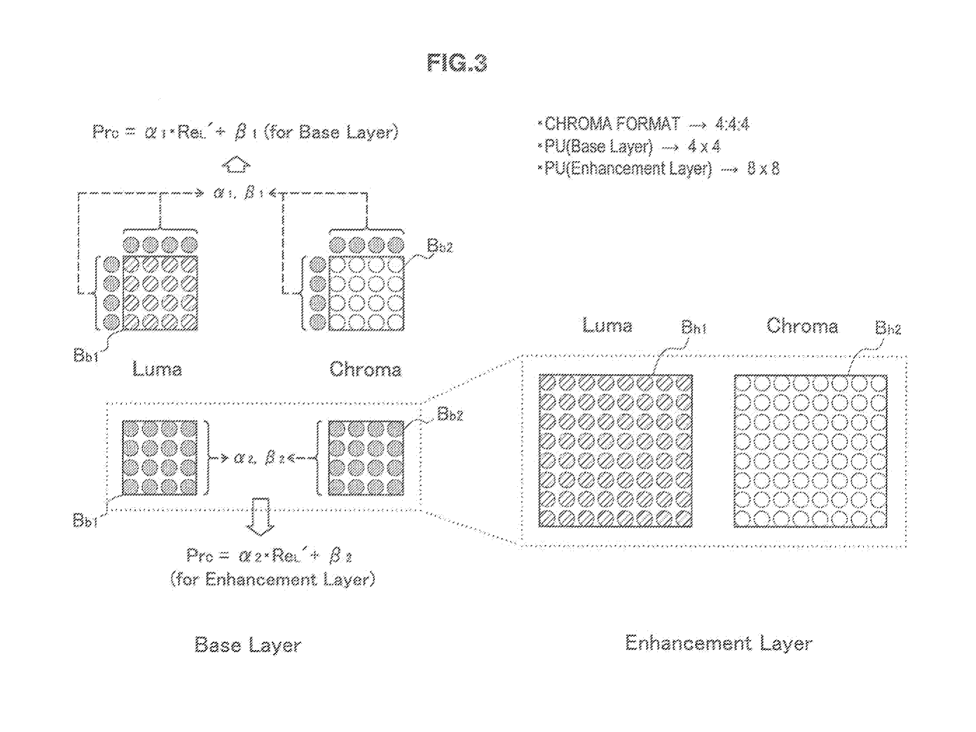

In the example of FIG. 3, to simplify the description, it is assumed that the chroma format is 4:4:4, the size of a prediction block in the base layer is 4×4 pixels, and the size of a prediction block in an enhancement layer is 8×8 pixels. FIG. 3 shows a prediction block B_{b1} of the luminance component and a prediction block B_{b2} of the color difference component in the base layer and a prediction block Bₕ₁ of the luminance component and a prediction block Bₕ₂ of the color difference component in an enhancement layer. Positions of these prediction blocks within an image correspond to each other (that is, these prediction blocks are present in common positions within an image). When the LM mode is applied to the prediction block B_{b2} of the color difference component in the base layer, a prediction function in LM mode is constructed by using coefficients α₁, β₁ calculated by substituting pixels values of neighboring blocks of the prediction blocks B_{b1}, B_{b2} into the Formula (2) and Formula (3). In the technology according to the present disclosure, by contrast, when the LM mode is applied to the prediction block Bₕ₂ of the color difference component in the enhancement layer, pixel values of the corresponding blocks B_{b1}, B_{b2} in a lower layer are substituted into the Formula (2) and Formula (3). Then, a prediction function for the enhancement layer is constructed by using coefficients α₂, β₂ calculated based on pixels values of these corresponding blocks.

The LM mode for the enhancement layer modified as described above can realize, when compared with the existing LM mode, higher prediction precision. In addition, even if, for example, a prediction mode (such as the DC prediction, planar prediction, or angular prediction) other than the LM mode is optimum in the base layer in terms of coding efficiency, room for the above modified LM mode to be able to achieve still higher coding efficiency in the enhancement layer arises. This is because while the LM mode in the base layer is based on correlations between color components of neighboring blocks whose position is different from that of the prediction block, the LM mode in the enhancement layer is based on correlations between color components of the corresponding block in a common position. Therefore, adopting the new LM mode described here as a candidate of at least estimation is useful regardless of which prediction mode is determined to be optimum in the base layer.

### 1-4. Basic Configuration Example of Encoder

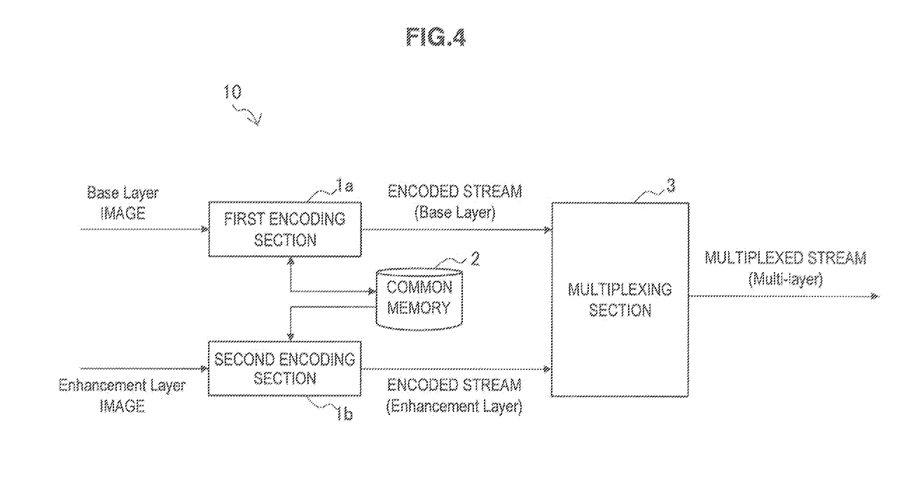

FIG. 4 is a block diagram showing a schematic configuration of an image encoding device 10 according to an embodiment supporting scalable video coding. Referring to FIG. 4, the image encoding device 10 includes a first encoding section 1a, a second encoding section 1b, a common memory 2, and a multiplexing section 3.

The first encoding section 1a encodes a base layer image to generate an encoded stream of the base layer. The second encoding section 1b encodes an enhancement layer image to generate an encoded stream of an enhancement layer. The common memory 2 stores information commonly used between layers. The multiplexing section 3 multiplexes an encoded stream of the base layer generated by the first encoding section 1a and an encoded stream of at least one enhancement layer generated by the second encoding section 1b to generate a multilayer multiplexed stream.

### 1-5. Basic Configuration Example of Decoder

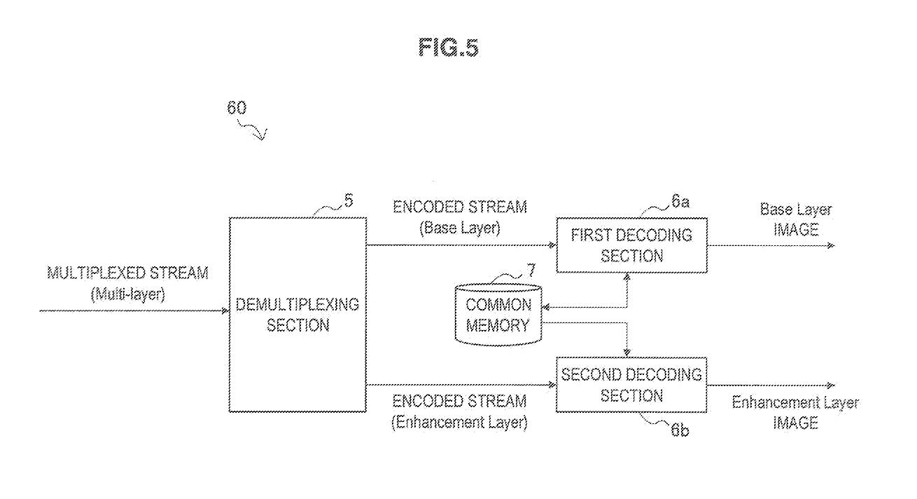

FIG. 5 is a block diagram showing a schematic configuration of an image decoding device 60 according to an embodiment supporting scalable video coding. Referring to FIG. 5, the image decoding device 60 includes a demultiplexing section 5, a first decoding section 6a, a second decoding section 6b, and a common memory 7.

The demultiplexing section 5 demultiplexes a multilayer multiplexed stream into an encoded stream of the base layer and an encoded stream of at least one enhancement layer. The first decoding section 6a decodes a base layer image from an encoded stream of the base layer. The second decoding section 6b decodes an enhancement layer image from an encoded stream of an enhancement layer. The common memory 7 stores information commonly used between layers.

In the image encoding device 10 illustrated in FIG. 4, the configuration of the first encoding section 1a to encode the base layer and that of the second encoding section 1b to encode an enhancement layer are similar to each other. Some parameters generated or acquired by the first encoding section 1a are buffered by using the common memory 2 and reused by the second encoding section 1b. In the next section, such a configuration of the first encoding section 1a and the second encoding section 1b will be described in detail.

Similarly, in the image decoding device 60 illustrated in FIG. 5, the configuration of the first decoding section 6a to decode the base layer and that of the second decoding section 6b to decode an enhancement layer are similar to each other. Some parameters generated or acquired by the first decoding section 6a are buffered by using the common memory 7 and reused by the second decoding section 6b. Further in the next section, such a configuration of the first decoding section 6a and the second decoding section 6b will be described in detail.

### 2. CONFIGURATION EXAMPLE OF ENCODING SECTION ACCORDING TO AN EMBODIMENT

### 2-1. Overall Configuration

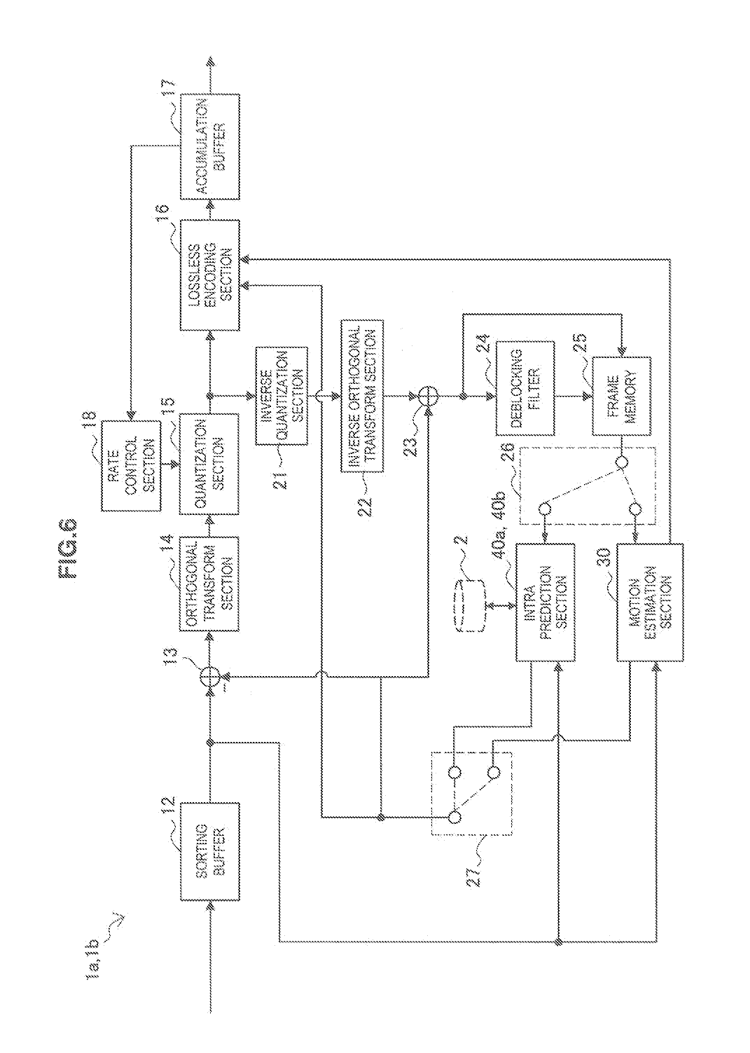

FIG. 6 is a block diagram showing an example of the configuration of the first encoding section 1a and the second encoding section 1b shown in FIG. 4. Referring to FIG. 6, the first encoding section 1a includes a sorting buffer 12, a subtraction section 13, an orthogonal transform section 14, a quantization section 15, a lossless encoding section 16, an accumulation buffer 17, a rate control section 18, an inverse quantization section 21, an inverse orthogonal transform section 22, an addition section 23, a deblocking filter 24, a frame memory 25, selectors 26, 27, a motion estimation section 30, and an intra prediction section 40a. The second encoding section 1b includes, instead of the intra prediction section 40a, an intra prediction section 40b.

The sorting buffer 12 sorts the images included in the series of image data. After sorting the images according to a GOP (Group of Pictures) structure according to the encoding process, the sorting buffer 12 outputs the image data which has been sorted to the subtraction section 13, the motion estimation section 30 and the intra prediction section 40a or 40b.

The image data input from the sorting buffer 12 and predicted image data input by the motion estimation section 30 or the intra prediction section 40a or 40b described later are supplied to the subtraction section 13. The subtraction section 13 calculates predicted error data which is a difference between the image data input from the sorting buffer 12 and the predicted image data and outputs the calculated predicted error data to the orthogonal transform section 14.

The orthogonal transform section 14 performs orthogonal transform on the predicted error data input from the subtraction section 13. The orthogonal transform to be performed by the orthogonal transform section 14 may be discrete cosine transform (DCT) or Karhunen-Loeve transform, for example. The orthogonal transform section 14 outputs transform coefficient data acquired by the orthogonal transform process to the quantization section 15.

The transform coefficient data input from the orthogonal transform section 14 and a rate control signal from the rate control section 18 described later are supplied to the quantization section 15. The quantization section 15 quantizes the transform coefficient data, and outputs the transform coefficient data which has been quantized (hereinafter, referred to as quantized data) to the lossless encoding section 16 and the inverse quantization section 21. Also, the quantization section 15 switches a quantization parameter (a quantization scale) based on the rate control signal from the rate control section 18 to thereby change the bit rate of the quantized data.

The lossless encoding section 16 generates an encoded stream of each layer by performing a lossless encoding process on quantized data of each layer input from the quantization section 15. The lossless encoding section 16 also encodes information about an intra prediction or information about an inter prediction input from the selector 27 and multiplexes encoded parameters into the header region of an encoded stream. Then, the lossless encoding section 16 outputs the generated encoded stream to the accumulation buffer 17.

The accumulation buffer 17 temporarily accumulates an encoded stream input from the lossless encoding section 16 using a storage medium such as a semiconductor memory. Then, the accumulation buffer 17 outputs the accumulated encoded stream to a transmission section (not shown) (for example, a communication interface or an interface to peripheral devices) at a rate in accordance with the band of a transmission path.

The rate control section 18 monitors the free space of the accumulation buffer 17. Then, the rate control section 18 generates a rate control signal according to the free space on the accumulation buffer 17, and outputs the generated rate control signal to the quantization section 15. For example, when there is not much free space on the accumulation buffer 17, the rate control section 18 generates a rate control signal for lowering the bit rate of the quantized data. Also, for example, when the free space on the accumulation buffer 17 is sufficiently large, the rate control section 18 generates a rate control signal for increasing the bit rate of the quantized data.

The inverse quantization section 21 performs an inverse quantization process on the quantized data input from the quantization section 15. Then, the inverse quantization section 21 outputs transform coefficient data acquired by the inverse quantization process to the inverse orthogonal transform section 22.

The inverse orthogonal transform section 22 performs an inverse orthogonal transform process on the transform coefficient data input from the inverse quantization section 21 to thereby restore the predicted error data. Then, the inverse orthogonal transform section 22 outputs the restored predicted error data to the addition section 23.

The addition section 23 adds the restored predicted error data input from the inverse orthogonal transform section 22 and the predicted image data input from the motion estimation section 30 or the intra prediction section 40a or 40b to thereby generate decoded image data (so-called reconstructed image). Then, the addition section 23 outputs the generated decoded image data to the deblocking filter 24 and the frame memory 25.

The deblocking filter 24 performs a filtering process for reducing block distortion occurring at the time of encoding of an image. The deblocking filter 24 filters the decoded image data input from the addition section 23 to remove the block distortion, and outputs the decoded image data after filtering to the frame memory 25.

The frame memory 25 stores, using a storage medium, the decoded image data input from the addition section 23 and the decoded image data after filtering input from the deblocking filter 24.

The selector 26 reads the decoded image data after filtering which is to be used for inter prediction from the frame memory 25, and supplies the decoded image data which has been read to the motion estimation section 30 as reference image data. Also, the selector 26 reads the decoded image data before filtering which is to be used for intra prediction from the frame memory 25, and supplies the decoded image data which has been read to the intra prediction section 40a or 40b as reference image data.

In the inter prediction mode, the selector 27 outputs predicted image data as a result of inter prediction output from the motion estimation section 30 to the subtraction section 13 and also outputs information about the inter prediction to the lossless encoding section 16. In the intra prediction mode, the selector 27 outputs predicted image data as a result of intra prediction output from the intra prediction section 40a or 40b to the subtraction section 13 and also outputs information about the intra prediction to the lossless encoding section 16. The selector 27 switches the inter prediction mode and the intra prediction mode in accordance with the magnitude of a cost function value output from the motion estimation section 30 and the intra prediction section 40a or 40b.

The motion estimation section 30 performs an inter prediction process (inter-frame prediction process) based on image data (original image data) to be encoded and input from the sorting buffer 12 and decoded image data supplied via the selector 26. For example, the motion estimation section 30 evaluates prediction results in each prediction mode using a predetermined cost function. Next, the motion estimation section 30 selects the prediction mode in which the cost function value takes the minimum value, that is, the prediction mode in which the compression rate is the highest as the optimum prediction mode. Also, the motion estimation section 30 generates predicted image data according to the optimum prediction mode. Then, the motion estimation section 30 outputs prediction mode information indicating the selected optimum prediction mode, information about the inter prediction including motion vector information and reference pixel information, the cost function value, and predicted image data to the selector 27.

The intra prediction section 40a performs an intra prediction process for each prediction block based on original image data and decoded image data of the base layer. For example, the intra prediction section 40a evaluates prediction results in each prediction mode using a predetermined cost function. Next, the intra prediction section 40a selects the prediction mode in which the cost function value is minimum, that is, the compression rate is the highest as the optimum prediction mode. Also, the intra prediction section 40a generates predicted image data of the base layer according to the optimum prediction mode. Then, the intra prediction section 40a outputs information about the intra prediction including prediction mode information indicating the selected optimum prediction mode, the cost function value, and predicted image data to the selector 27. Also, the intra prediction section 40a causes the common memory 2 to buffer at least a portion of parameters about the intra prediction.

The intra prediction section 40b performs the intra prediction process for each prediction block based on original image data and decoded image data of an enhancement layer. For example, the intra prediction section 40b evaluates prediction results in each prediction mode using a predetermined cost function. Next, the intra prediction section 40b selects the prediction mode in which the cost function value takes the minimum value, that is, the prediction mode in which the compression rate is the highest as the optimum prediction mode. Also, the intra prediction section 40b generates predicted image data of an enhancement layer according to the optimum prediction mode. Then, the intra prediction section 40b outputs information about the intra prediction including prediction mode information indicating the selected optimum prediction mode, the cost function value, and predicted image data to the selector 27. Prediction mode candidates estimated for the enhancement layer can contain the new LM mode modified as described above. When applying the new LM mode to some prediction block, the intra prediction section 40b refers to pixels values of the luminance component and the color difference component in the corresponding position in a lower layer that can be buffered by the common memory 2. The intra prediction section 40b may narrow down prediction mode candidates estimated for the enhancement layer based on prediction mode information of a lower layer than can additionally be buffered by the common memory 2. When only one prediction mode candidate remains, the one prediction mode may be selected as the optimum prediction mode.

The first encoding section 1a performs a series of encoding processes described here on a sequence of image data of the base layer. The second encoding section 1b performs a series of encoding processes described here on a sequence of image data of an enhancement layer. When a plurality of enhancement layers is present, the encoding process of the enhancement layer can be repeated as many times as the number of enhancement layers. The encoding process of the base layer and that of an enhancement layer may be performed by being synchronized for each block, for example.

In this specification, an example in which both of the base layer and the enhancement layer are encoded and decoded according to HEVC will mainly be described. The prediction block in this specification corresponds to the prediction unit (PU) meaning a processing unit of a prediction process in HEVC. However, the technology according to the present disclosure can also be applied to a case when at least one layer is encoded and decoded according to another image coding scheme such as MPEG2 or AVC. For example, the base layer may be encoded and decoded by an image coding scheme that does not support the LM mode. The technology according to the present disclosure can also be applied to a multi-view, instead of multi-layer, image coding scheme.

### 2-2. Detailed Configuration of Intra Prediction Section

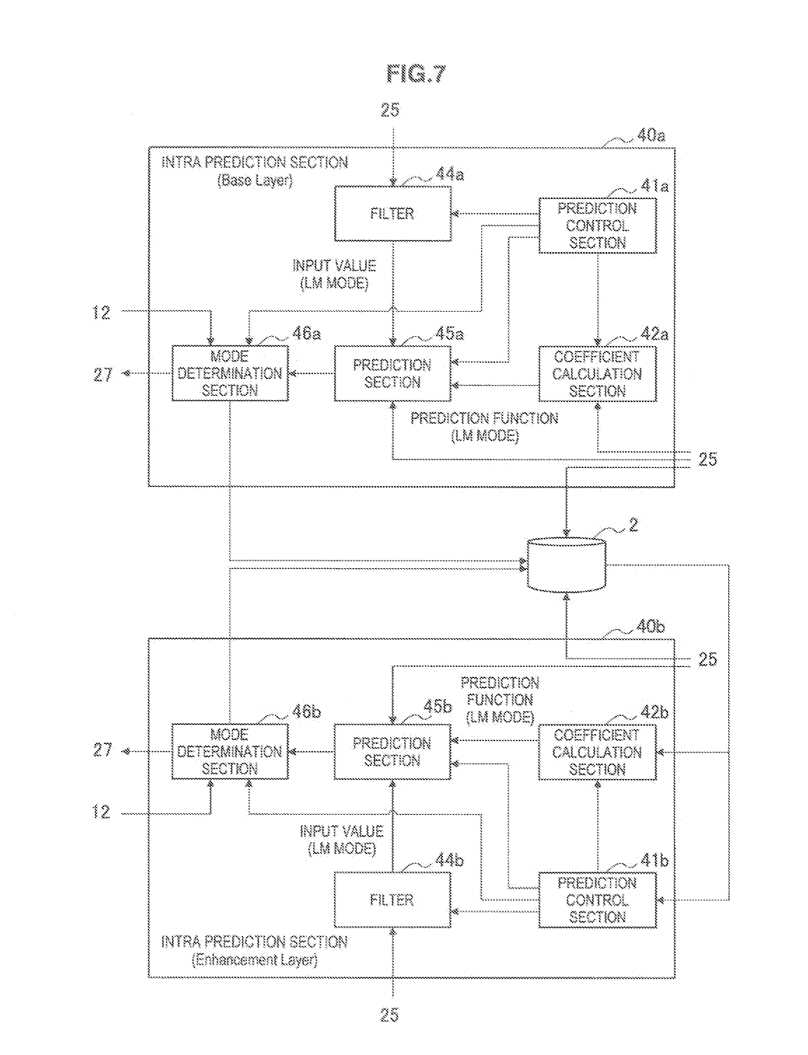

FIG. 7 is a block diagram showing an example of a detailed configuration of the intra prediction sections 40a, 40b shown in FIG. 6. Referring to FIG. 7, the intra prediction section 40a includes a prediction control section 41a, a coefficient calculation section 42a, a filter 44a, a prediction section 45a, and a mode determination section 46a. The intra prediction section 40b includes a prediction control section 41b, a coefficient calculation section 42b, a filter 44b, a prediction section 45b, and a mode determination section 46b.

### (1) Intra Prediction Process of the Base Layer

The prediction control section 41a of the intra prediction section 40a controls the intra prediction process of the base layer. For example, the prediction control section 41a performs the intra prediction process for the luminance component and the intra prediction process for the color difference component for each prediction block. In the intra prediction process for each color component, the prediction control section 41a causes the prediction section 45a to generate a predicted image of each prediction block in a plurality of prediction modes and causes the mode determination section 46a to determine the optimum prediction mode. When the base layer is encoded according to HEVC, prediction mode candidates (hereinafter, called candidate modes) of the color difference component contain the LM mode. The LM mode in the base layer is the existing LM mode described by using FIG. 2.

The coefficient calculation section 42a calculates coefficients of a prediction function used by the prediction section 45a in LM mode by substituting pixel values of neighboring blocks into the Formula (2) and Formula (3). The filter 44a generates an input value into the prediction function in LM mode by down-sampling (phase shifting) pixel values of the luminance component of the prediction block input from the frame memory 25 in accordance with the chroma format.

The prediction section 45a generates a predicted image of each prediction block for each color component (that is, each of the luminance component and the color difference component) according to various candidate modes under the control of the prediction control section 41a. When the candidate mode is the LM mode, the prediction section 45a predicts the value of each color difference component by substituting the input value of the luminance component generated by the filter 44a into a prediction function having coefficients calculated by the coefficient calculation section 42a. Predicted images in other candidate modes may also be generated in the same manner as existing techniques. The prediction section 45a outputs predicted image data generated as a result of prediction to the mode determination section 46a for each prediction mode.

The mode determination section 46a calculates the cost function value for each prediction mode based on original image data input from the sorting buffer 12 and predicted image data input from the prediction section 45a. Then, the mode determination section 46a selects the optimum prediction mode for each color component based on the calculated cost function value. Then, the mode determination section 46a outputs information about the intra prediction including prediction mode information indicating the selected optimum prediction mode, the cost function value, and predicted image data of each color component to the selector 27.

The common memory 2 stores decoded image data input from the frame memory 25 before a deblocking filter being applied. The decoded image data contains pixel values of the luminance component and the color difference component. The decoded image data stored in the common memory 2 is referred to by the intra prediction section 40b when coefficients of a prediction function for the new LM mode in an upper layer are calculated. The mode determination section 46a may cause the common memory 2 to store prediction mode information indicating the optimum prediction mode for each prediction block. The prediction mode information is used to narrow down candidate modes in an upper layer.

### (2) Intra Prediction Process of an Enhancement Layer

The prediction control section 41b of the intra prediction section 40b controls the intra prediction process of an enhancement layer. For example, the prediction control section 41b performs the intra prediction process for the luminance component and the intra prediction process for the color difference component for each prediction block. In the intra prediction process for each color component, the prediction control section 41b causes the prediction section 45b to generate a predicted image of each prediction block in one or more prediction modes and causes the mode determination section 46b to determine the optimum prediction mode. Candidate modes of the color difference component contain the new LM mode described by using FIG. 3.

The coefficient calculation section 42b acquires pixel values of the luminance component and the color difference component of a lower layer in a position corresponding to the prediction block from the common memory 2. Then, the coefficient calculation section 42b calculates coefficients of a prediction function for the new LM mode by substituting the pixel values acquired from the common memory 2 into the Formula (2) and Formula (3). The filter 44b generates an input value into the prediction function by down-sampling (phase shifting) pixel values of the luminance component of the prediction block input from the frame memory 25 in accordance with the chroma format.

The prediction section 45b generates a predicted image of each prediction block for each color component (that is, each of the luminance component and the color difference component) according to various candidate modes under the control of the prediction control section 41b. When the candidate mode is the LM mode, the prediction section 45b predicts the value of each color difference component by substituting the input value of the luminance component generated by the filter 44b into a prediction function having coefficients calculated by the coefficient calculation section 42b. Predicted images in other candidate modes may be generated in the same manner as existing techniques. The prediction section 45b outputs predicted image data generated as a result of prediction to the mode determination section 46b for each prediction mode.

The mode determination section 46b calculates the cost function value for each prediction mode based on original image data input from the sorting buffer 12 and predicted image data input from the prediction section 45b. Then, the mode determination section 46b selects the optimum prediction mode for each color component based on the calculated cost function value. Then, the mode determination section 46b outputs information about the intra prediction including prediction mode information indicating the selected optimum prediction mode, the cost function value, and predicted image data of each color component to the selector 27.

The prediction control section 41b may narrow down candidate modes of the prediction block in the enhancement layer based on prediction mode information of the corresponding block in a lower layer that can be buffered by the common memory 2.

When, for example, the prediction mode information indicates that the LM mode is selected for the corresponding block as the optimum prediction mode, the prediction control section 41b may narrow down candidate modes of the prediction mode to the new LM mode only. Because the new LM mode is assumed to have higher prediction precision than the existing LM mode, when the LM mode is selected as the optimum in a lower layer, the new LM mode is likely to be necessarily optimum in a higher layer. Thus, the processing cost necessary to estimate the prediction mode can be reduced by such narrowing down. In addition, there is no need to encode separate prediction mode information for the prediction block in the enhancement layer so that coding efficiency can be increased.

On the other hand, when a non-LM mode is selected for the corresponding block as the optimum prediction mode, the prediction control section 41b includes the new LM mode among candidate modes for the prediction block. Thus, regardless of whether a non-LM mode is selected for the corresponding block, coding efficiency can effectively be increased by including the new LM mode for the prediction block in the enhancement layer to make the most of the new LM mode capable of realizing high prediction precision.

When only one candidate mode remains, the comparison of cost function values by the mode determination section 46b may be omitted to select the one candidate mode as the optimum prediction mode.

When a still higher layer is present, the common memory 2 may further store decoded image data of an enhancement layer input from the frame memory 25 before the deblocking filter being applied. The mode determination section 46b may cause the common memory 2 to store prediction mode information indicating the optimum prediction mode for each prediction block for the still higher layer.

As described above, the value of I in Formula (2) and Formula (3) represents the number of reference pixels. If the size of one side of the prediction block of the color difference component is S_{B}, I is 2*S_{B} for the existing LM mode. In the new LM mode, by contrast, the value of I may be different. When, for example, the scalability ratio is 2:1, the size of one side of the corresponding block is S_{B}/2 and I is given by (S_{B}/2)². If the block size increases, the number I of reference pixels in the new LM mode can become large when compared with the existing LM mode. The cost necessary for calculating Formula (2) and Formula (3) increases with an increasing number I of reference pixels. Thus, when applying the new LM mode, the coefficient calculation section 42b may reduce the processing cost of the coefficient calculation process by thinning out reference pixels in a lower layer.

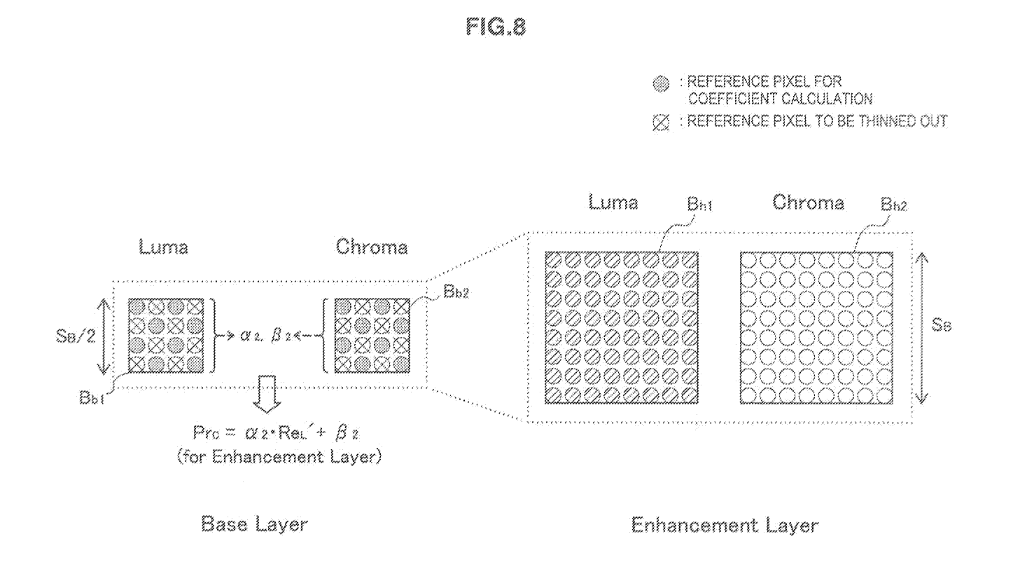

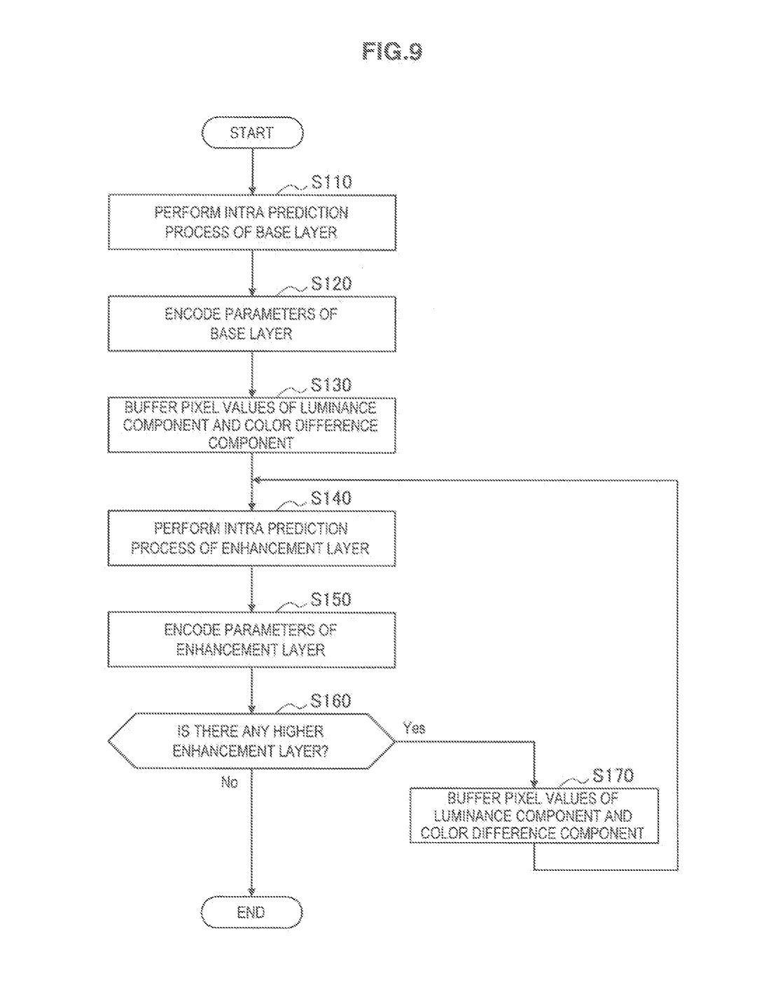

FIG. 8 is an explanatory view illustrating an example of thinning out reference pixels. Referring to FIG. 8, like in FIG. 3, prediction blocks in an enhancement layer having the size of 8×8 pixels and the corresponding blocks in the base layer having the size of 4:4 pixels are shown. It is also assumed here that the chroma format is 4:4:4 to simplify the description. When the LM mode is applied to the prediction block Bₕ₂ of the color difference component in the enhancement layer, pixel values of the prediction blocks B_{b1}, B_{b2} in the lower layer are substituted into coefficient calculation formulae by the coefficient calculation section 42b. In the example of FIG. 8, however, the coefficient calculation section 42b substitutes, instead of all pixel values of the prediction blocks B₁, B_{b2}, only a portion (for example, shaded pixels in FIG. 8) thereof into the coefficient calculation formulae. Accordingly, the processing cost of the coefficient calculation cost can be reduced. Incidentally, positions of reference pixels to be thinned out are not limited to those shown in the example of FIG. 8 and may be any position. Also, the ratio of reference pixels to be thinned out is not limited to that shown in the example of FIG. 8 and may be any ratio. The position or the ratio of reference pixels to be thinned out may dynamically be set depending on a parameter such as the block size.

### 3. FLOW OF PROCESS FOR ENCODING ACCORDING TO AN EMBODIMENT

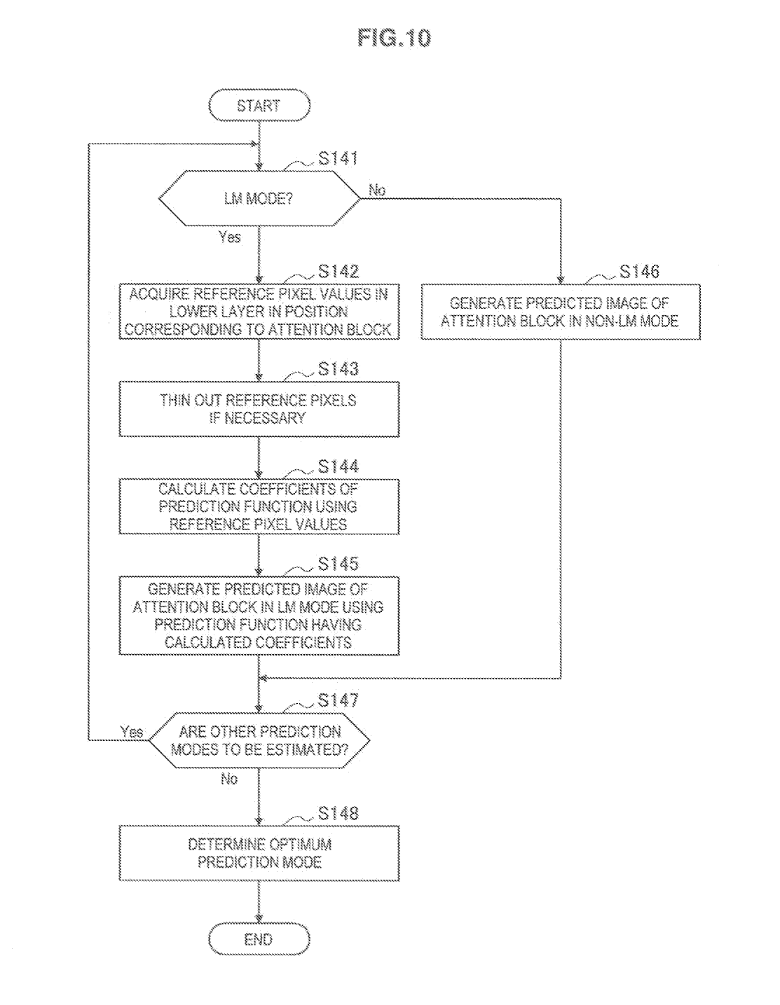

In this section, the flow of a process for encoding will be described using FIGS. 9 and 10.

### (1) Schematic Flow

FIG. 9 is a flow chart showing an example of a schematic process flow for encoding according to an embodiment. For the sake of brevity of description, processing steps that are not directly related to technology of the present disclosure are omitted.

Referring to FIG. 9, first the intra prediction section 40a for the base layer performs the intra prediction process of the base layer (step S110). The intra prediction process here may be a process according to specifications as defined in, for example, Non-Patent Literature 1 described above. Next, the lossless encoding section 16 generates an encoded stream of the base layer by encoding information about the intra prediction generated as a result of the intra prediction process and quantized data (step S120). The common memory 2 buffers pixels values of the luminance component and the color difference component of the base layer before the deblocking filter being applied (step S130).

Next, the intra prediction section 40b for an enhancement layer performs the intra prediction process of the enhancement layer (step S140). The intra prediction process here will be described in detail later. Next, the lossless encoding section 16 generates an encoded stream of the enhancement layer by encoding information about the intra prediction generated as a result of the intra prediction process and quantized data (step S150).

Thereafter, whether a higher enhancement layer is present is determined (step S160). If a higher enhancement layer is present, pixel values of the luminance component and the color difference component of the enhancement layer before the deblocking filter being applied are buffered by the common memory 2 (step S170) and the process returns to step S140. On the other hand, if no higher enhancement layer is present, the flow chart in FIG. 9 ends.

### (2) Intra Prediction Process of an Enhancement Layer

FIG. 10 is a flow chart showing an example of a detailed flow of the intra prediction process of an enhancement layer in step S140 of FIG. 9.

The prediction block to be processed in the flow chart of FIG. 10 is called an attention block here. For the attention block, one or more candidate modes including the new LM mode may be present. The intra prediction process of an enhancement layer branches in accordance with the candidate mode to be processed (step S141). If the candidate mode to be processed is the LM mode, the process proceeds to step S142. Otherwise, the process proceeds to step S146.

In the process in LM mode, the coefficient calculation section 42b acquires reference pixel values of the luminance component and the color difference component of a lower layer in a position corresponding to the attention block from the common memory 2 (step S142). Next, the coefficient calculation section 42b thins out acquired reference pixels if necessary (for example, when the number of reference pixels is larger than a predetermined threshold) (step S143). Next, the coefficient calculation section 42b calculates coefficients α, β of a prediction function in LM mode by substituting reference pixel values of the luminance component and the color difference component into coefficient calculation formulae (step S144). Next, the prediction section 45b generates a predicted image of the attention block by substituting the input value of the luminance component generated by the filter 44b into the prediction function having coefficients calculated by the coefficient calculation section 42b (step S145).

On the other hand, in a non-LM mode process, the prediction section 45b generates a predicted image of the attention block according to the prediction mode specified by the prediction control section 41b (step S145).

These processes are repeated until all candidate modes are estimated for the attention block (step S147). Then, when all candidate modes are estimated, the mode determination section 46b selects the optimum prediction mode from one or more candidate modes by comparing cost function values (step S148).

### 4. CONFIGURATION EXAMPLE OF DECODING SECTION ACCORDING TO AN EMBODIMENT

### 4-1. Overall Configuration Example

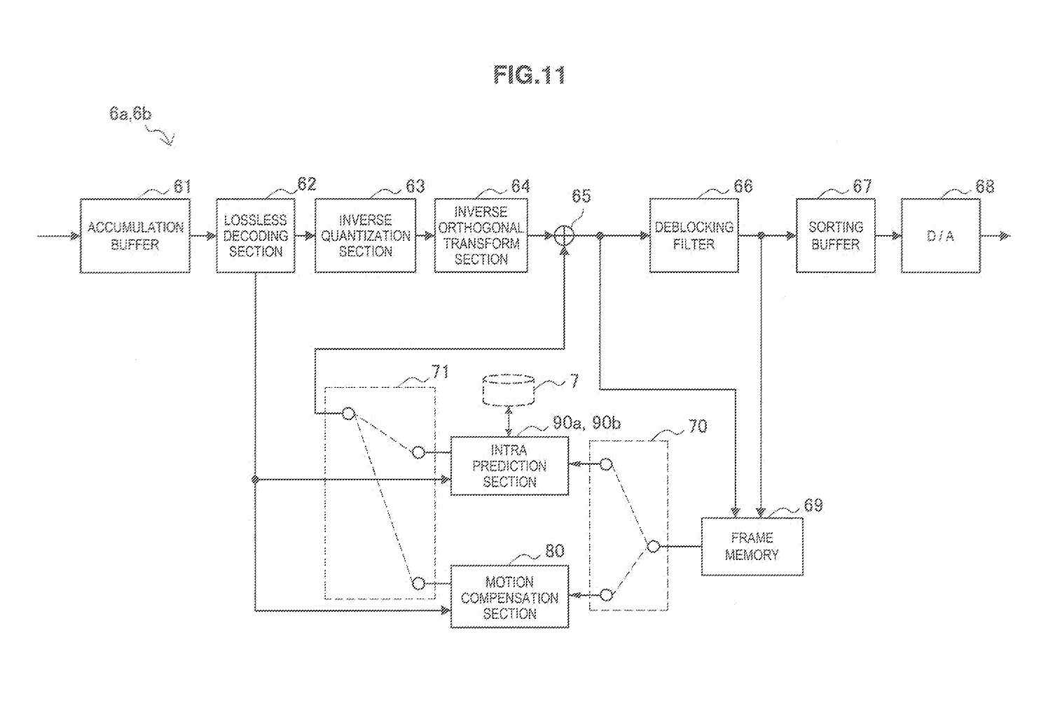

FIG. 11 is a block diagram showing an example of the configuration of the first decoding section 6a and the second decoding section 6b shown in FIG. 5. Referring to FIG. 11, the first decoding section 6a includes an accumulation buffer 61, a lossless decoding section 62, an inverse quantization section 63, an inverse orthogonal transform section 64, an addition section 65, a deblocking filter 66, a sorting buffer 67, a D/A (Digital to Analogue) conversion section 68, a frame memory 69, selectors 70, 71, a motion compensation section 80, and an intra prediction section 90a. The second decoding section 6b includes, instead of the intra prediction section 90a, an intra prediction section 90b.

The accumulation buffer 61 temporarily accumulates an encoded stream input via a transmission path using a storage medium.

The lossless decoding section 62 decodes an encoded stream of the base layer input from the accumulation buffer 61 according to the coding scheme used at the time of encoding. The lossless decoding section 62 also decodes information multiplexed in the header region of the encoded stream. The information decoded by the lossless decoding section 62 may contain, for example, the information about inter prediction and the information about intra prediction described above. The lossless decoding section 62 outputs the information about inter prediction to the motion compensation section 80. The lossless decoding section 62 also outputs the information about intra prediction to the intra prediction section 90a or 90b.

The inverse quantization section 63 inversely quantizes quantized data which has been decoded by the lossless decoding section 62. The inverse orthogonal transform section 64 generates predicted error data by performing inverse orthogonal transformation on transform coefficient data input from the inverse quantization section 63 according to the orthogonal transformation method used at the time of encoding. Then, the inverse orthogonal transform section 64 outputs the generated predicted error data to the addition section 65.

The addition section 65 adds the predicted error data input from the inverse orthogonal transform section 64 and predicted image data input from the selector 71 to thereby generate decoded image data. Then, the addition section 65 outputs the generated decoded image data to the deblocking filter 66 and the frame memory 69.

The deblocking filter 66 removes block distortion by filtering the decoded image data input from the addition section 65, and outputs the decoded image data after filtering to the sorting buffer 67 and the frame memory 69.

The sorting buffer 67 generates a series of image data in a time sequence by sorting images input from the deblocking filter 66. Then, the sorting buffer 67 outputs the generated image data to the D/A conversion section 68.

The D/A conversion section 68 converts the image data in a digital format input from the sorting buffer 67 into an image signal in an analogue format. Then, the D/A conversion section 68 causes an image to be displayed by outputting the analogue image signal to a display (not shown) connected to the image decoding device 60, for example.

The frame memory 69 stores, using a storage medium, the decoded image data before filtering input from the addition section 65, and the decoded image data after filtering input from the deblocking filter 66.

The selector 70 switches the output destination of the image data from the frame memory 62 between the motion compensation section 80 and the intra prediction section 90a or 90b for each block in the image according to mode information acquired by the lossless decoding section 62a or 62b. For example, in the case the inter prediction mode is specified, the selector 70 outputs the decoded image data after filtering that is supplied from the frame memory 69 to the motion compensation section 80 as the reference image data. Also, in the case the intra prediction mode is specified, the selector 70 outputs the decoded image data before filtering that is supplied from the frame memory 69 to the intra prediction section 90a or 90b as reference image data.

The selector 71 switches the output source of predicted image data to be supplied to the addition section 65 between the motion compensation section 80 and the intra prediction section 90a or 90b according to the mode information acquired by the lossless decoding section 62. For example, in the case the inter prediction mode is specified, the selector 71 supplies to the addition section 65 the predicted image data output from the motion compensation section 80. Also, in the case the intra prediction mode is specified, the selector 71 supplies to the addition section 65 the predicted image data output from the intra prediction section 90a or 90b.

The motion compensation section 80 performs a motion compensation process based on the information about inter prediction input from the lossless decoding section 62 and the reference image data from the frame memory 69, and generates predicted image data. Then, the motion compensation section 80 outputs the generated predicted image data to the selector 71.

The intra prediction section 90a performs an intra prediction process of the base layer based on the information about intra prediction input from the lossless decoding section 62 and the reference image data from the frame memory 69, and generates predicted image data. Then, the intra prediction section 90a outputs the generated predicted image data of the base layer to the selector 71. Also, the intra prediction section 40a causes the common memory 7 to buffer at least a portion of parameters about the intra prediction.

The intra prediction section 90b performs the intra prediction process of the enhancement layer based on the information about intra prediction input from the lossless decoding section 62 and the reference image data from the frame memory 69, and generates predicted image data. Then, the intra prediction section 90b outputs the generated predicted image data of the enhancement layer to the selector 71. Candidate modes specified for the enhancement layer can contain the aforementioned new LM mode. When applying the new LM mode to some prediction block, the intra prediction section 90b refers to pixels values of the luminance component and the color difference component in the corresponding position in a lower layer that can be buffered by the common memory 7. The intra prediction section 90b may narrow down candidate modes of the enhancement layer based on prediction mode information of a lower layer that can additionally be buffered by the common memory 7. When only one candidate mode remains, prediction mode information of the enhancement layer is not decoded.

The first decoding section 6a performs a series of decoding processes described here on a sequence of image data of the base layer. The second decoding section 6b performs a series of decoding processes described here on a sequence of image data of the enhancement layer. When a plurality of enhancement layers is present, the decoding process of the enhancement layer can be repeated as many times as the number of enhancement layers. The decoding process of the base layer and that of an enhancement layer may be performed by being synchronized for each block, for example.

### 4-2. Detailed Configuration of Intra Prediction Section

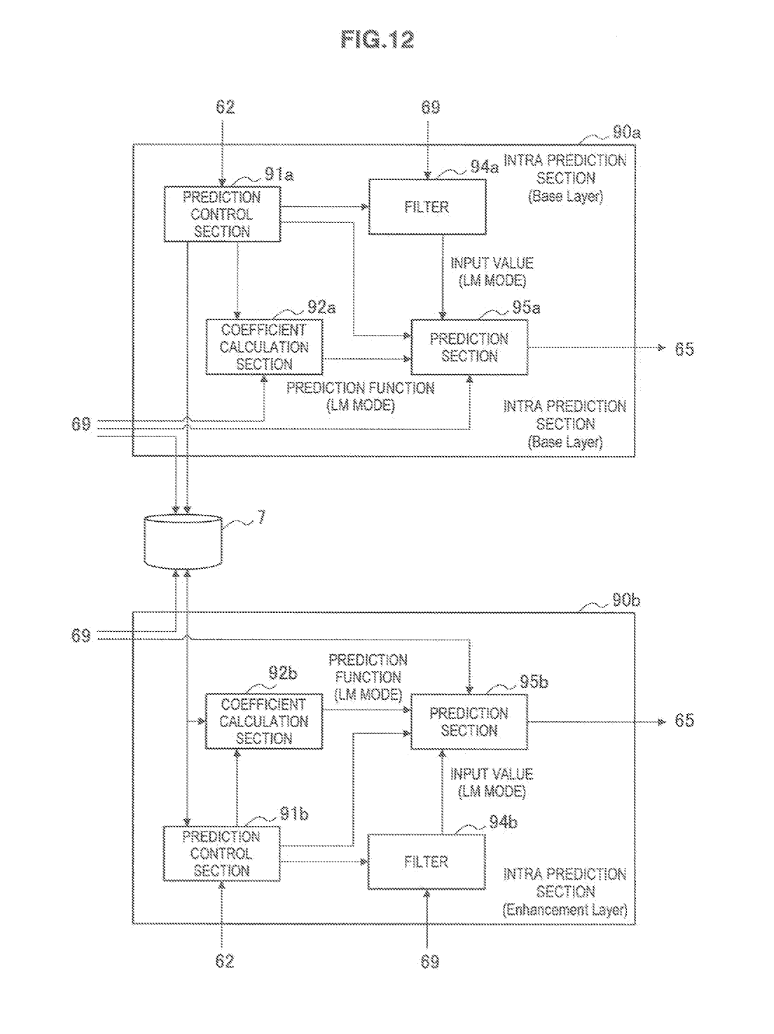

FIG. 12 is a block diagram showing an example of the detailed configuration of the intra prediction sections 90a, 90b shown in FIG. 11. Referring to FIG. 12, the intra prediction section 90a includes a prediction control section 91a, a coefficient calculation section 92a, a filter 94a, and a prediction section 95a. The intra prediction section 90b includes a prediction control section 91b, a coefficient calculation section 92b, a filter 94b, and a prediction section 95b.

### (1) Intra Prediction Process of the Base Layer

The prediction control section 91a of the intra prediction section 90a controls the intra prediction process of the base layer. For example, the prediction control section 91a performs the intra prediction process for the luminance component and the intra prediction process for the color difference component for each prediction block. In the intra prediction process for each color component, the prediction control section 91a acquires prediction mode information decoded by the lossless decoding section 62. Then, the prediction control section 91a causes the prediction section 95a to generate a predicted image of each prediction block in the prediction mode specified by the prediction mode information. When the base layer is decoded according to HEVC, the prediction mode information can indicate the LM mode for the color difference component. The LM mode in the base layer is the existing LM mode described by using FIG. 2.

The coefficient calculation section 92a calculates coefficients of a prediction function used by the prediction section 95a in LM mode by substituting pixel values of neighboring blocks into the Formula (2) and Formula (3). The filter 94a generates an input value into the prediction function in LM mode by down-sampling (phase shifting) pixel values of the luminance component of the prediction block input from the frame memory 69 in accordance with the chroma format.

The prediction section 95a generates a predicted image of each prediction block for each color component (that is, each of the luminance component and the color difference component) according to the specified prediction mode under the control of the prediction control section 91a. When the candidate mode is the LM mode, the prediction section 95a predicts the value of each color difference component by substituting the input value of the luminance component generated by the filter 94a into a prediction function having coefficients calculated by the coefficient calculation section 92a. Predicted images in other prediction modes may also be generated in the same manner as existing techniques. Then, the prediction section 95a outputs predicted image data generated as a result of prediction to the addition section 65.

The common memory 7 stores decoded image data input from the frame memory 69 before the deblocking filter being applied. The decoded image data contains pixel values of the luminance component and the color difference component. The decoded image data stored in the common memory 7 is referred to by the intra prediction section 90b when coefficients of a prediction function for the new LM mode in an upper layer are calculated. The prediction control section 91a may cause the common memory 7 to store prediction mode information indicating the prediction mode specified for each prediction block. The prediction mode information is used to narrow down prediction modes in an upper layer.

### (2) Intra Prediction Process of an Enhancement Layer

The prediction control section 91b of the intra prediction section 90b controls the intra prediction process of an enhancement layer. For example, the prediction control section 91b performs the intra prediction process for the luminance component and the intra prediction process for the color difference component for each prediction block. In the intra prediction process for each color component, the prediction control section 91b acquires prediction mode information decoded by the lossless decoding section 62. Then, the prediction control section 91b causes the prediction section 95b to generate a predicted image of each prediction block in the prediction mode specified by the prediction mode information. The prediction mode information can indicate the new LM mode described by using FIG. 3 for the color difference component.

The coefficient calculation section 92b acquires pixel values of the luminance component and the color difference component of a lower layer in a position corresponding to the prediction block from the common memory 7. Then, the coefficient calculation section 92b calculates coefficients of a prediction function for the new LM mode by substituting the pixel values acquired from the common memory 7 into the Formula (2) and Formula (3). The filter 94b generates an input value into the prediction function by down-sampling (phase shifting) pixel values of the luminance component of the prediction block input from the frame memory 69 in accordance with the chroma format.

The prediction section 95b generates a predicted image of each prediction block for each color component (that is, each of the luminance component and the color difference component) according to the prediction mode specified by the prediction control section 91b. When the LM mode is specified, the prediction section 95b predicts the value of each color difference component by substituting the input value of the luminance component generated by the filter 94b into a prediction function having coefficients calculated by the coefficient calculation section 92b. Predicted images in other prediction modes may be generated in the same manner as existing techniques. The prediction section 95b outputs predicted image data generated as a result of prediction to the addition section 65.

The prediction control section 91b may narrow down prediction modes of the prediction block in the enhancement layer based on prediction mode information of the corresponding block in a lower layer that can be buffered by the common memory 7.

When, for example, the LM mode is specified for the corresponding block based on the prediction mode information, the prediction control section 91b may narrow down prediction modes of the prediction mode to the new LM mode only. In this case, separate prediction mode information is not decoded from an encoded stream for the prediction block in the enhancement layer.

On the other hand, when a non-LM mode is specified for the corresponding block based on the prediction mode information, the prediction control section 91b acquires separate prediction mode information for the prediction block. Then, if the acquired separate prediction mode information indicates the LM mode, the prediction control section 91b causes the prediction section 95b to generate a predicted image of the prediction block according to the new LM mode.

When a still higher layer is present, the common memory 7 may further store decoded image data of an enhancement layer input from the frame memory 69 before the deblocking filter being applied. The prediction control section 91b may cause the common memory 7 to store prediction mode information indicating the prediction mode specified for each prediction block for the still higher layer.

When applying the new LM mode, the coefficient calculation section 92b may, as described using FIG. 8, reduce the processing cost of the coefficient calculation process by thinning out reference pixels in a lower layer.

### 5. FLOW OF PROCESS FOR DECODING ACCORDING TO AN EMBODIMENT

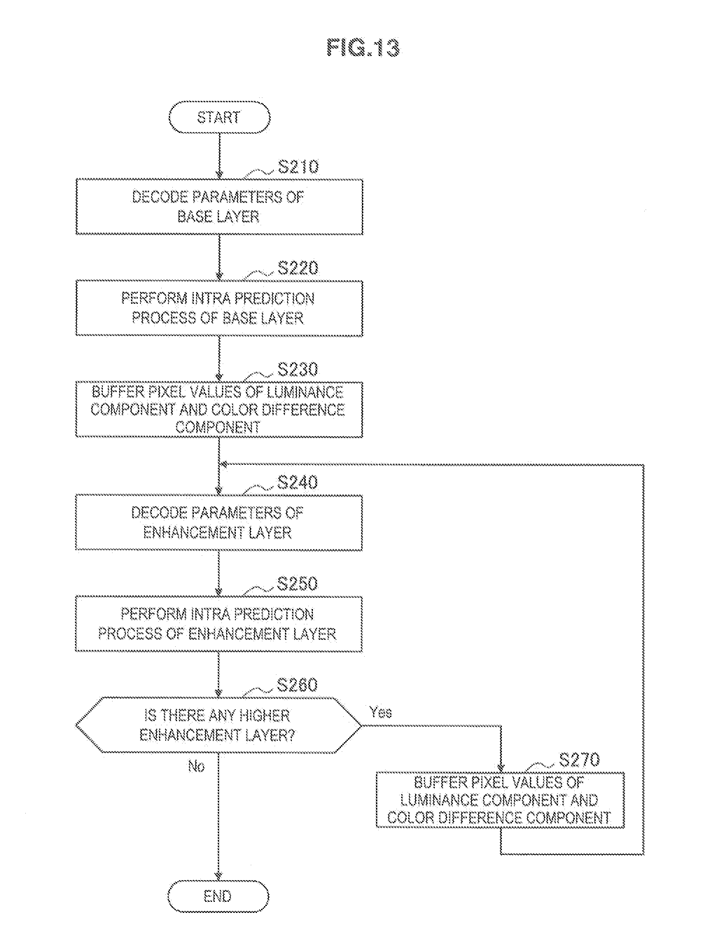

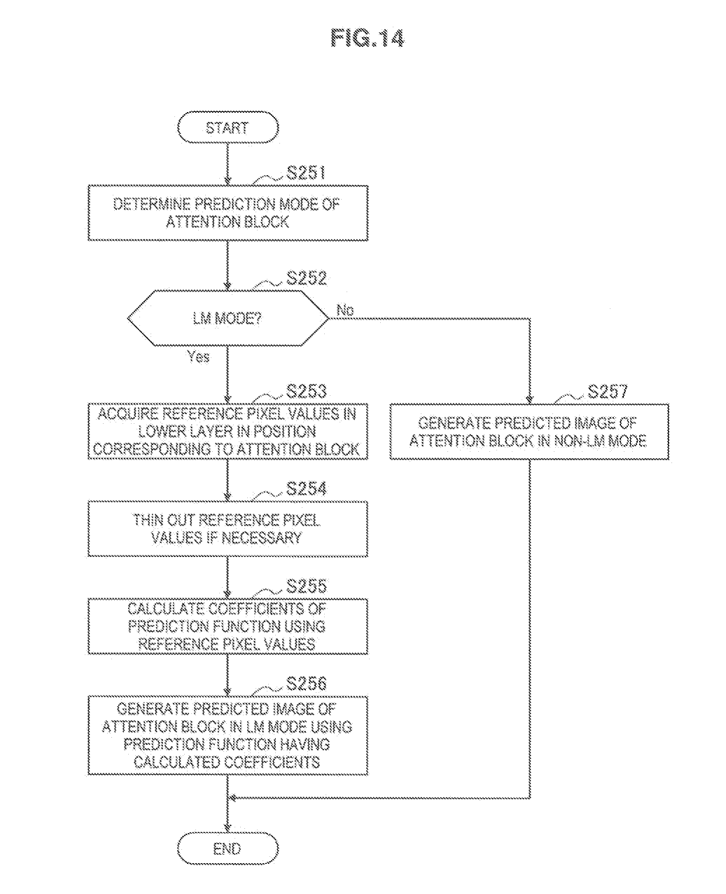

In this section, the flow of a process for decoding will be described using FIGS. 13 and 14.

### (1) Schematic Flow

FIG. 13 is a flow chart showing an example of the schematic process flow for decoding according to an embodiment. For the sake of brevity of description, processing steps that are not directly related to technology of the present disclosure are omitted.

Referring to FIG. 13, first the lossless decoding section 62 decodes information about the intra prediction of the base layer and quantized data from an encoded stream of the base layer (step S210). Next, the intra prediction section 90a for the base layer performs the intra prediction process of the base layer (step S220). The intra prediction process here may be a process according to specifications as defined in, for example, Non-Patent Literature 1 described above. The common memory 7 buffers pixels values of the luminance component and the color difference component of the base layer before the deblocking filter being applied (step S230).

Next, the lossless decoding section 62 decodes information about the intra prediction of an enhancement layer and quantized data from an encoded stream of the enhancement layer (step S240). Next, the intra prediction section 90b for the enhancement layer performs the intra prediction process of the enhancement layer (step S250). The intra prediction process here will be described in detail later.

Thereafter, whether a higher enhancement layer is present is determined (step S260). If a higher enhancement layer is present, pixel values of the luminance component and the color difference component of the enhancement layer before the deblocking filter being applied are buffered by the common memory 7 (step S270) and the process returns to step S240. On the other hand, if no higher enhancement layer is present, the flow chart in FIG. 13 ends.

### (2) Intra Prediction Process of an Enhancement Layer

FIG. 14 is a flow chart showing an example of the detailed flow of the intra prediction process of the enhancement layer in step S250 of FIG. 13.

The prediction block to be processed in the flow chart of FIG. 14 is called an attention block here. First, the prediction control section 91b determines the prediction mode of the attention block (step S251). For example, the prediction control section 91b may determine the prediction mode of the attention block by acquiring separate prediction mode information for the enhancement layer decoded by the lossless decoding section 62. Also, if prediction modes can be narrowed down to one prediction mode from prediction mode information of the corresponding block in the base layer, the prediction control section 91b may determine the prediction mode of the attention block without acquiring separate prediction mode information for the enhancement layer. The subsequent process branches in accordance with the prediction mode of the determined attention block (step S252). If the prediction mode of the attention block is the LM mode, the process proceeds to step S253. Otherwise, the process proceeds to step S257.

In the process in LM mode, the coefficient calculation section 92b acquires reference pixel values of the luminance component and the color difference component of a lower layer in a position corresponding to the attention block from the common memory 7 (step S53). Next, the coefficient calculation section 92b thins out acquired reference pixels if necessary (for example, when the number of reference pixels is larger than a predetermined threshold) (step S254). Next, the coefficient calculation section 92b calculates coefficients α, β of a prediction function in LM mode by substituting reference pixel values of the luminance component and the color difference component into coefficient calculation formulae (step S255). Next, the prediction section 95b generates a predicted image of the attention block by substituting the input value of the luminance component generated by the filter 94b into the prediction function having coefficients calculated by the coefficient calculation section 92b (step S256).

On the other hand, in a non-LM mode process, the prediction section 95b generates a predicted image of the attention block according to the prediction mode specified by the prediction control section 91b (step S257).

### 6. EXAMPLE APPLICATION

### 6-1. Application to Various Products

The image encoding device 10 and the image decoding device 60 according to the embodiment described above may be applied to various electronic appliances such as a transmitter and a receiver for satellite broadcasting, cable broadcasting such as cable TV, distribution on the Internet, distribution to terminals via cellular communication, and the like, a recording device that records images in a medium such as an optical disc, a magnetic disk or a flash memory, a reproduction device that reproduces images from such storage medium, and the like. Four example applications will be described below.

### (1) First Application Example

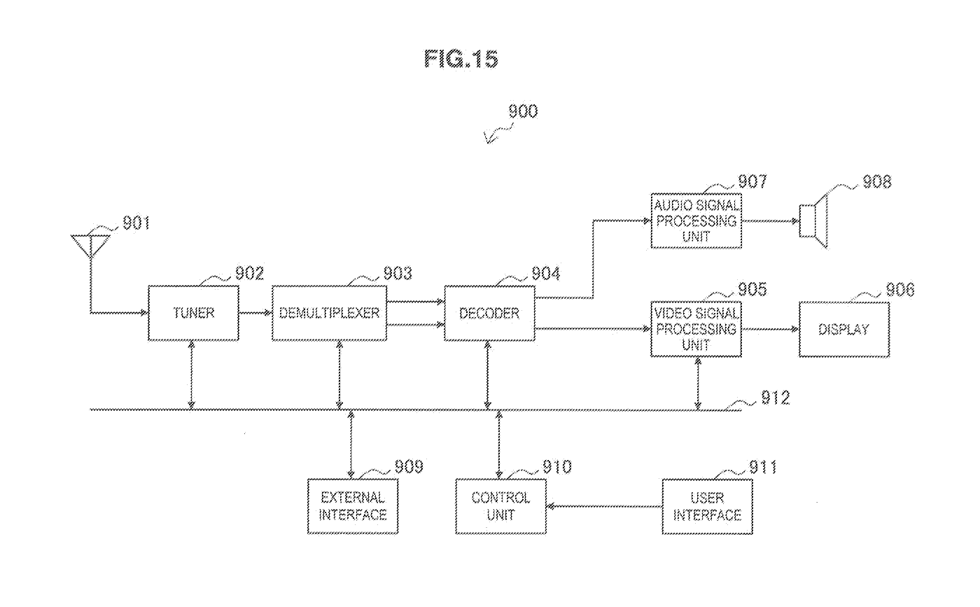

FIG. 15 is a diagram illustrating an example of a schematic configuration of a television device applying the aforementioned embodiment. A television device 900 includes an antenna 901, a tuner 902, a demultiplexer 903, a decoder 904, a video signal processing unit 905, a display 906, an audio signal processing unit 907, a speaker 908, an external interface 909, a control unit 910, a user interface 911, and a bus 912.

The tuner 902 extracts a signal of a desired channel from a broadcast signal received through the antenna 901 and demodulates the extracted signal. The tuner 902 then outputs an encoded bit stream obtained by the demodulation to the demultiplexer 903. That is, the tuner 902 has a role as transmission means receiving the encoded stream in which an image is encoded, in the television device 900.

The demultiplexer 903 isolates a video stream and an audio stream in a program to be viewed from the encoded bit stream and outputs each of the isolated streams to the decoder 904. The demultiplexer 903 also extracts auxiliary data such as an EPG (Electronic Program Guide) from the encoded bit stream and supplies the extracted data to the control unit 910. Here, the demultiplexer 903 may descramble the encoded bit stream when it is scrambled.

The decoder 904 decodes the video stream and the audio stream that are input from the demultiplexer 903. The decoder 904 then outputs video data generated by the decoding process to the video signal processing unit 905. Furthermore, the decoder 904 outputs audio data generated by the decoding process to the audio signal processing unit 907.

The video signal processing unit 905 reproduces the video data input from the decoder 904 and displays the video on the display 906. The video signal processing unit 905 may also display an application screen supplied through the network on the display 906. The video signal processing unit 905 may further perform an additional process such as noise reduction on the video data according to the setting. Furthermore, the video signal processing unit 905 may generate an image of a GUI (Graphical User Interface) such as a menu, a button, or a cursor and superpose the generated image onto the output image.

The display 906 is driven by a drive signal supplied from the video signal processing unit 905 and displays video or an image on a video screen of a display device (such as a liquid crystal display, a plasma display, or an OELD (Organic ElectroLuminescence Display)).

The audio signal processing unit 907 performs a reproducing process such as D/A conversion and amplification on the audio data input from the decoder 904 and outputs the audio from the speaker 908. The audio signal processing unit 907 may also perform an additional process such as noise reduction on the audio data.

The external interface 909 is an interface that connects the television device 900 with an external device or a network. For example, the decoder 904 may decode a video stream or an audio stream received through the external interface 909. This means that the external interface 909 also has a role as the transmission means receiving the encoded stream in which an image is encoded, in the television device 900.

The control unit 910 includes a processor such as a C prediction block (CPU) and a memory such as a RAM and a ROM. The memory stores a program executed by the C prediction block, program data, EPG data, and data acquired through the network. The program stored in the memory is read by the C prediction block at the start-up of the television device 900 and executed, for example. By executing the program, the C prediction block controls the operation of the television device 900 in accordance with an operation signal that is input from the user interface 911, for example.

The user interface 911 is connected to the control unit 910. The user interface 911 includes a button and a switch for a user to operate the television device 900 as well as a reception part which receives a remote control signal, for example. The user interface 911 detects a user operation through these components, generates the operation signal, and outputs the generated operation signal to the control unit 910.

The bus 912 mutually connects the tuner 902, the demultiplexer 903, the decoder 904, the video signal processing unit 905, the audio signal processing unit 907, the external interface 909, and the control unit 910.

The decoder 904 in the television device 900 configured in the aforementioned manner has a function of the image decoding device 60 according to the aforementioned embodiment. Accordingly, prediction precision can further be improved for scalable video decoding of images in the television device 900 by adopting the new LM mode in an enhancement layer.

### (2) Second Application Example

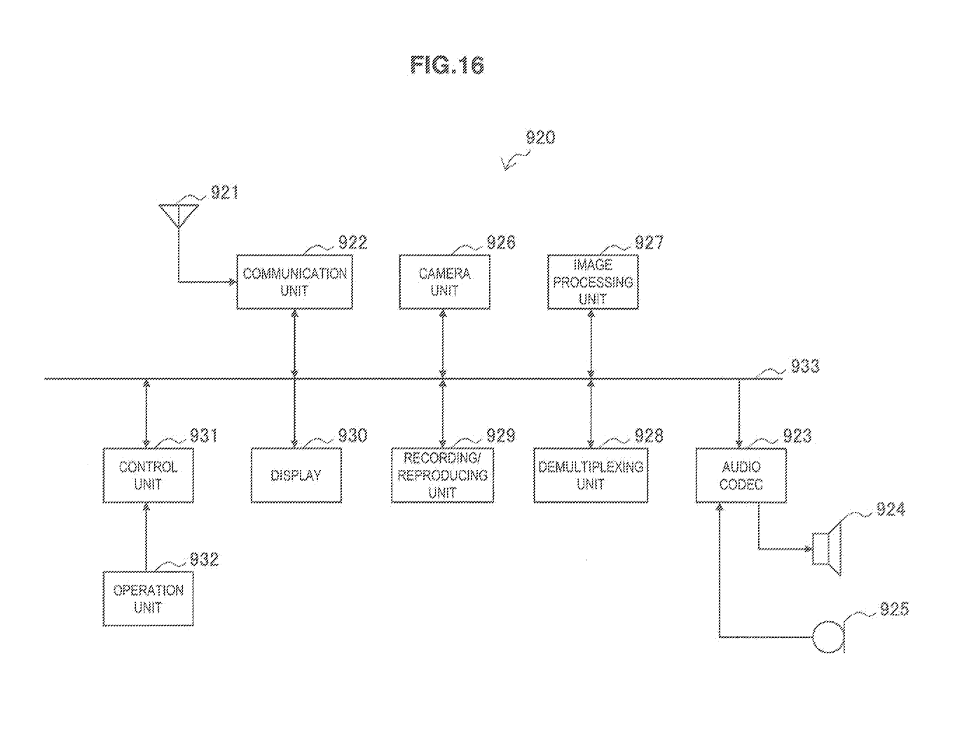

FIG. 16 is a diagram illustrating an example of a schematic configuration of a mobile telephone applying the aforementioned embodiment. A mobile telephone 920 includes an antenna 921, a communication unit 922, an audio codec 923, a speaker 924, a microphone 925, a camera unit 926, an image processing unit 927, a demultiplexing unit 928, a recording/reproducing unit 929, a display 930, a control unit 931, an operation unit 932, and a bus 933.

The antenna 921 is connected to the communication unit 922. The speaker 924 and the microphone 925 are connected to the audio codec 923. The operation unit 932 is connected to the control unit 931. The bus 933 mutually connects the communication unit 922, the audio codec 923, the camera unit 926, the image processing unit 927, the demultiplexing unit 928, the recording/reproducing unit 929, the display 930, and the control unit 931.

The mobile telephone 920 performs an operation such as transmitting/receiving an audio signal, transmitting/receiving an electronic mail or image data, imaging an image, or recording data in various operation modes including an audio call mode, a data communication mode, a photography mode, and a videophone mode.

In the audio call mode, an analog audio signal generated by the microphone 925 is supplied to the audio codec 923. The audio codec 923 then converts the analog audio signal into audio data, performs A/D conversion on the converted audio data, and compresses the data. The audio codec 923 thereafter outputs the compressed audio data to the communication unit 922. The communication unit 922 encodes and modulates the audio data to generate a transmission signal. The communication unit 922 then transmits the generated transmission signal to a base station (not shown) through the antenna 921. Furthermore, the communication unit 922 amplifies a radio signal received through the antenna 921, converts a frequency of the signal, and acquires a reception signal. The communication unit 922 thereafter demodulates and decodes the reception signal to generate the audio data and output the generated audio data to the audio codec 923. The audio codec 923 expands the audio data, performs D/A conversion on the data, and generates the analog audio signal. The audio codec 923 then outputs the audio by supplying the generated audio signal to the speaker 924.

In the data communication mode, for example, the control unit 931 generates character data configuring an electronic mail, in accordance with a user operation through the operation unit 932. The control unit 931 further displays a character on the display 930. Moreover, the control unit 931 generates electronic mail data in accordance with a transmission instruction from a user through the operation unit 932 and outputs the generated electronic mail data to the communication unit 922. The communication unit 922 encodes and modulates the electronic mail data to generate a transmission signal. Then, the communication unit 922 transmits the generated transmission signal to the base station (not shown) through the antenna 921. The communication unit 922 further amplifies a radio signal received through the antenna 921, converts a frequency of the signal, and acquires a reception signal. The communication unit 922 thereafter demodulates and decodes the reception signal, restores the electronic mail data, and outputs the restored electronic mail data to the control unit 931. The control unit 931 displays the content of the electronic mail on the display 930 as well as stores the electronic mail data in a storage medium of the recording/reproducing unit 929.

The recording/reproducing unit 929 includes an arbitrary storage medium that is readable and writable. For example, the storage medium may be a built-in storage medium such as a RAM or a flash memory, or may be an externally-mounted storage medium such as a hard disk, a magnetic disk, a magneto-optical disk, an optical disk, a USB (Unallocated Space Bitmap) memory, or a memory card.

In the photography mode, for example, the camera unit 926 images an object, generates image data, and outputs the generated image data to the image processing unit 927. The image processing unit 927 encodes the image data input from the camera unit 926 and stores an encoded stream in the storage medium of the storing/reproducing unit 929.

In the videophone mode, for example, the demultiplexing unit 928 multiplexes a video stream encoded by the image processing unit 927 and an audio stream input from the audio codec 923, and outputs the multiplexed stream to the communication unit 922. The communication unit 922 encodes and modulates the stream to generate a transmission signal. The communication unit 922 subsequently transmits the generated transmission signal to the base station (not shown) through the antenna 921. Moreover, the communication unit 922 amplifies a radio signal received through the antenna 921, converts a frequency of the signal, and acquires a reception signal. The transmission signal and the reception signal can include an encoded bit stream. Then, the communication unit 922 demodulates and decodes the reception signal to restore the stream, and outputs the restored stream to the demultiplexing unit 928. The demultiplexing unit 928 isolates the video stream and the audio stream from the input stream and outputs the video stream and the audio stream to the image processing unit 927 and the audio codec 923, respectively. The image processing unit 927 decodes the video stream to generate video data. The video data is then supplied to the display 930, which displays a series of images. The audio codec 923 expands and performs D/A conversion on the audio stream to generate an analog audio signal. The audio codec 923 then supplies the generated audio signal to the speaker 924 to output the audio.

The image processing unit 927 in the mobile telephone 920 configured in the aforementioned manner has a function of the image encoding device 10 and the image decoding device 60 according to the aforementioned embodiment. Accordingly, for scalable video coding and decoding of images by the mobile telephone 920, the prediction accuracy can be further increased by adopting a new LM mode in an enhancement layer.

### (3) Third Application Example

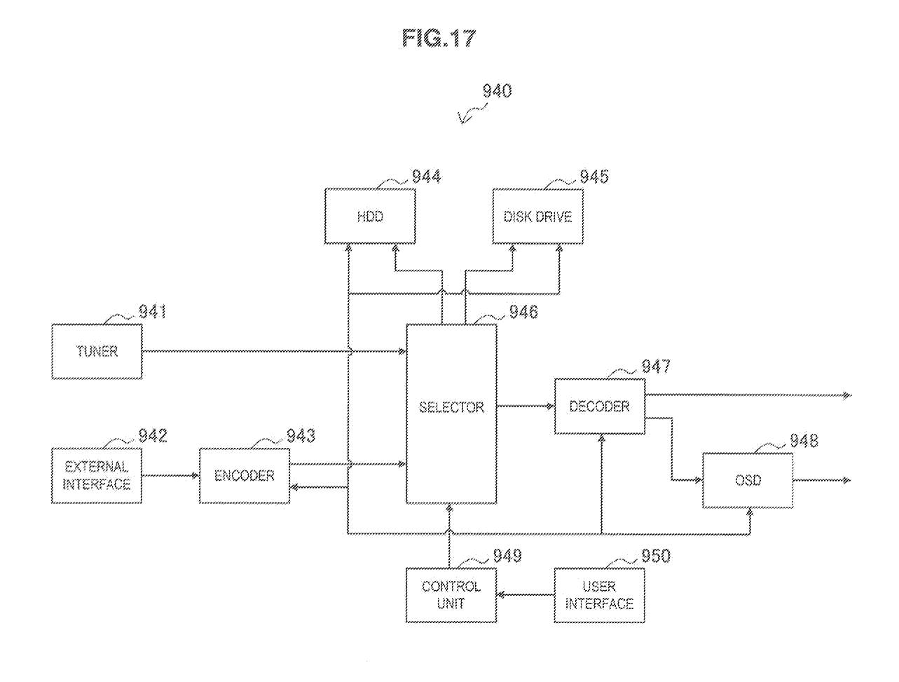

FIG. 17 is a diagram illustrating an example of a schematic configuration of a recording/reproducing device applying the aforementioned embodiment. A recording/reproducing device 940 encodes audio data and video data of a broadcast program received and records the data into a recording medium, for example. The recording/reproducing device 940 may also encode audio data and video data acquired from another device and record the data into the recording medium, for example. In response to a user instruction, for example, the recording/reproducing device 940 reproduces the data recorded in the recording medium on a monitor and a speaker. The recording/reproducing device 940 at this time decodes the audio data and the video data.

The recording/reproducing device 940 includes a tuner 941, an external interface 942, an encoder 943, an HDD (Hard Disk Drive) 944, a disk drive 945, a selector 946, a decoder 947, an OSD (On-Screen Display) 948, a control unit 949, and a user interface 950.

The tuner 941 extracts a signal of a desired channel from a broadcast signal received through an antenna (not shown) and demodulates the extracted signal. The tuner 941 then outputs an encoded bit stream obtained by the demodulation to the selector 946. That is, the tuner 941 has a role as transmission means in the recording/reproducing device 940.

The external interface 942 is an interface which connects the recording/reproducing device 940 with an external device or a network. The external interface 942 may be, for example, an IEEE 1394 interface, a network interface, a USB interface, or a flash memory interface. The video data and the audio data received through the external interface 942 are input to the encoder 943, for example. That is, the external interface 942 has a role as transmission means in the recording/reproducing device 940.

The encoder 943 encodes the video data and the audio data when the video data and the audio data input from the external interface 942 are not encoded. The encoder 943 thereafter outputs an encoded bit stream to the selector 946.

The HDD 944 records, into an internal hard disk, the encoded bit stream in which content data such as video and audio is compressed, various programs, and other data. The HDD 944 reads these data from the hard disk when reproducing the video and the audio.

The disk drive 945 records and reads data into/from a recording medium which is mounted to the disk drive. The recording medium mounted to the disk drive 945 may be, for example, a DVD disk (such as DVD-Video, DVD-RAM, DVD-R, DVD-RW, DVD+R, or DVD+RW) or a Blu-ray (Registered Trademark) disk.

The selector 946 selects the encoded bit stream input from the tuner 941 or the encoder 943 when recording the video and audio, and outputs the selected encoded bit stream to the HDD 944 or the disk drive 945. When reproducing the video and audio, on the other hand, the selector 946 outputs the encoded bit stream input from the HDD 944 or the disk drive 945 to the decoder 947.

The decoder 947 decodes the encoded bit stream to generate the video data and the audio data. The decoder 904 then outputs the generated video data to the OSD 948 and the generated audio data to an external speaker.

The OSD 948 reproduces the video data input from the decoder 947 and displays the video. The OSD 948 may also superpose an image of a GUI such as a menu, a button, or a cursor onto the video displayed.

The control unit 949 includes a processor such as a C prediction block and a memory such as a RAM and a ROM. The memory stores a program executed by the C prediction block as well as program data. The program stored in the memory is read by the C prediction block at the start-up of the recording/reproducing device 940 and executed, for example. By executing the program, the C prediction block controls the operation of the recording/reproducing device 940 in accordance with an operation signal that is input from the user interface 950, for example.

The user interface 950 is connected to the control unit 949. The user interface 950 includes a button and a switch for a user to operate the recording/reproducing device 940 as well as a reception part which receives a remote control signal, for example. The user interface 950 detects a user operation through these components, generates the operation signal, and outputs the generated operation signal to the control unit 949.

The encoder 943 in the recording/reproducing device 940 configured in the aforementioned manner has a function of the image encoding device 10 according to the aforementioned embodiment. On the other hand, the decoder 947 has a function of the image decoding device 60 according to the aforementioned embodiment. Accordingly, for scalable video coding and decoding of images by the recording/reproducing device 940, the prediction accuracy can be further increased by adopting a new LM mode in an enhancement layer.

### (4) Fourth Application Example

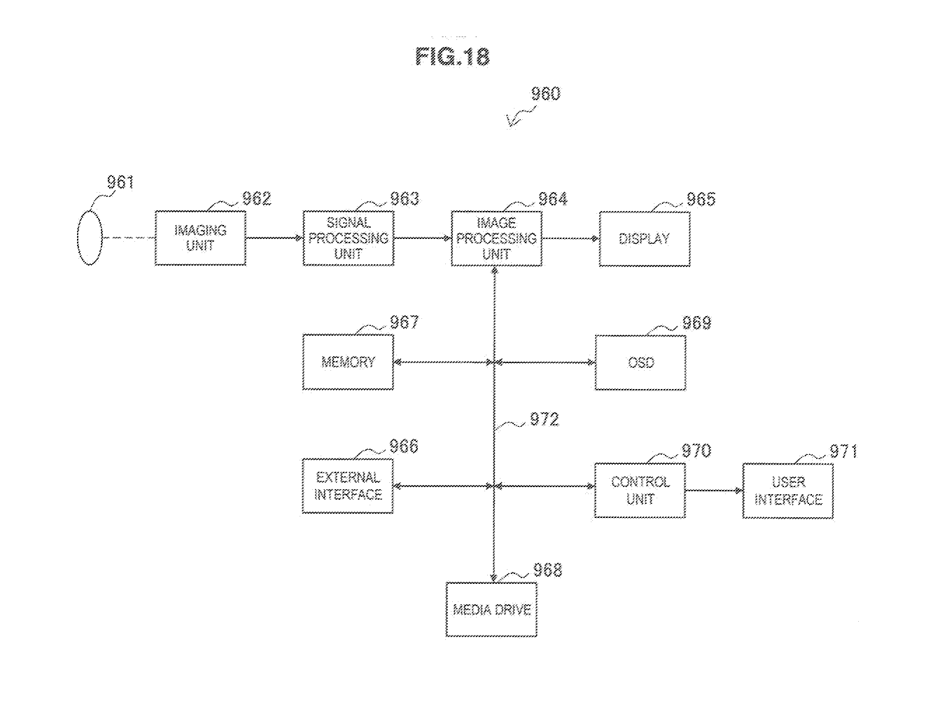

FIG. 18 shows an example of a schematic configuration of an image capturing device applying the aforementioned embodiment. An imaging device 960 images an object, generates an image, encodes image data, and records the data into a recording medium.

The imaging device 960 includes an optical block 961, an imaging unit 962, a signal processing unit 963, an image processing unit 964, a display 965, an external interface 966, a memory 967, a media drive 968, an OSD 969, a control unit 970, a user interface 971, and a bus 972.

The optical block 961 is connected to the imaging unit 962. The imaging unit 962 is connected to the signal processing unit 963. The display 965 is connected to the image processing unit 964. The user interface 971 is connected to the control unit 970. The bus 972 mutually connects the image processing unit 964, the external interface 966, the memory 967, the media drive 968, the OSD 969, and the control unit 970.

The optical block 961 includes a focus lens and a diaphragm mechanism. The optical block 961 forms an optical image of the object on an imaging surface of the imaging unit 962. The imaging unit 962 includes an image sensor such as a CCD (Charge Coupled Device) or a CMOS (Complementary Metal Oxide Semiconductor) and performs photoelectric conversion to convert the optical image formed on the imaging surface into an image signal as an electric signal. Subsequently, the imaging unit 962 outputs the image signal to the signal processing unit 963.

The signal processing unit 963 performs various camera signal processes such as a knee correction, a gamma correction and a color correction on the image signal input from the imaging unit 962. The signal processing unit 963 outputs the image data, on which the camera signal process has been performed, to the image processing unit 964.

The image processing unit 964 encodes the image data input from the signal processing unit 963 and generates the encoded data. The image processing unit 964 then outputs the generated encoded data to the external interface 966 or the media drive 968. The image processing unit 964 also decodes the encoded data input from the external interface 966 or the media drive 968 to generate image data. The image processing unit 964 then outputs the generated image data to the display 965. Moreover, the image processing unit 964 may output to the display 965 the image data input from the signal processing unit 963 to display the image. Furthermore, the image processing unit 964 may superpose display data acquired from the OSD 969 onto the image that is output on the display 965.

The OSD 969 generates an image of a GUI such as a menu, a button, or a cursor and outputs the generated image to the image processing unit 964.

The external interface 966 is configured as a USB input/output terminal, for example. The external interface 966 connects the imaging device 960 with a printer when printing an image, for example. Moreover, a drive is connected to the external interface 966 as needed. A removable medium such as a magnetic disk or an optical disk is mounted to the drive, for example, so that a program read from the removable medium can be installed to the imaging device 960. The external interface 966 may also be configured as a network interface that is connected to a network such as a LAN or the Internet. That is, the external interface 966 has a role as transmission means in the imaging device 960.

The recording medium mounted to the media drive 968 may be an arbitrary removable medium that is readable and writable such as a magnetic disk, a magneto-optical disk, an optical disk, or a semiconductor memory. Furthermore, the recording medium may be fixedly mounted to the media drive 968 so that a non-transportable storage unit such as a built-in hard disk drive or an SSD (Solid State Drive) is configured, for example.

The control unit 970 includes a processor such as a C prediction block and a memory such as a RAM and a ROM. The memory stores a program executed by the C prediction block as well as program data. The program stored in the memory is read by the C prediction block at the start-up of the imaging device 960 and then executed. By executing the program, the C prediction block controls the operation of the imaging device 960 in accordance with an operation signal that is input from the user interface 971, for example.

The user interface 971 is connected to the control unit 970. The user interface 971 includes a button and a switch for a user to operate the imaging device 960, for example. The user interface 971 detects a user operation through these components, generates the operation signal, and outputs the generated operation signal to the control unit 970.

The image processing unit 964 in the imaging device 960 configured in the aforementioned manner has a function of the image encoding device 10 and the image decoding device 60 according to the aforementioned embodiment. Accordingly, for scalable video coding and decoding of images by the imaging device 960, the prediction accuracy can be further increased by adopting a new LM mode in an enhancement layer.

### 6-2. Various Uses of Scalable Video Coding

Advantages of scalable video coding described above can be enjoyed in various uses. Three examples of use will be described below.

### (1) First Example

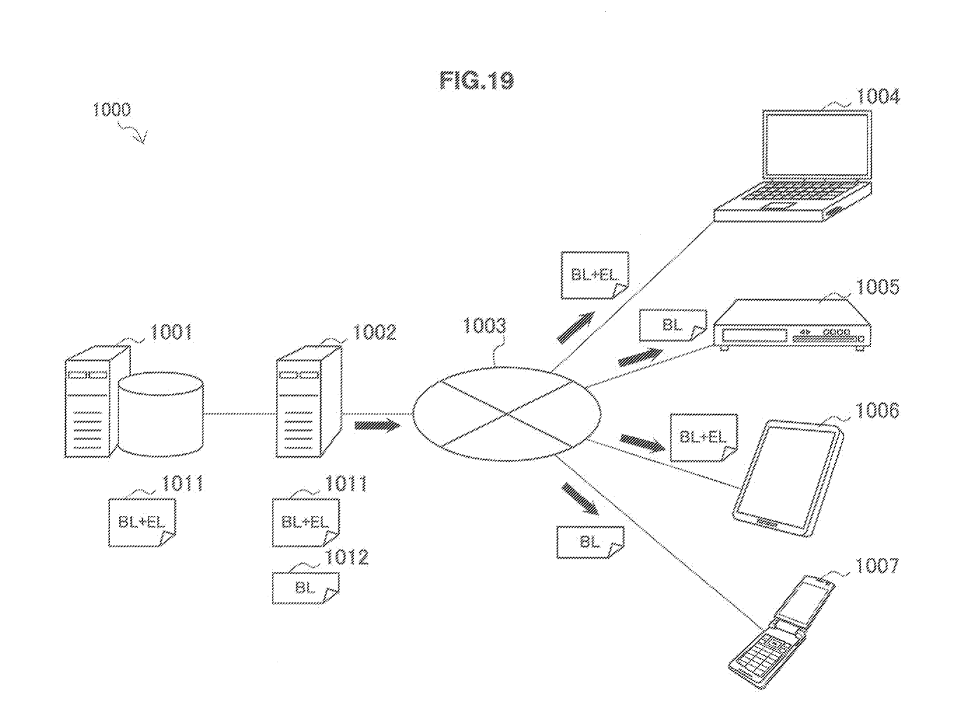

In the first example, scalable video coding is used for selective transmission of data. Referring to FIG. 19, a data transmission system 1000 includes a stream storage device 1001 and a delivery server 1002. The delivery server 1002 is connected to some terminal devices via a network 1003. The network 1003 may be a wire network or a wireless network or a combination thereof. FIG. 19 shows a PC (Personal Computer) 1004, an AV device 1005, a tablet device 1006, and a mobile phone 1007 as examples of the terminal devices.

The stream storage device 1001 stores, for example, stream data 1011 including a multiplexed stream generated by the image encoding device 10. The multiplexed stream includes an encoded stream of the base layer (BL) and an encoded stream of an enhancement layer (EL). The delivery server 1002 reads the stream data 1011 stored in the stream storage device 1001 and delivers at least a portion of the read stream data 1011 to the PC 1004, the AV device 1005, the tablet device 1006, and the mobile phone 1007 via the network 1003.

When a stream is delivered to a terminal device, the delivery server 1002 selects the stream to be delivered based on some condition such as capabilities of a terminal device or the communication environment. For example, the delivery server 1002 may avoid a delay in a terminal device or an occurrence of overflow or overload of a processor by not delivering an encoded stream having high image quality exceeding image quality that can be handled by the terminal device. The delivery server 1002 may also avoid occupation of communication bands of the network 1003 by not delivering an encoded stream having high image quality. On the other hand, when there is no risk to be avoided or it is considered to be appropriate based on a user's contract or some condition, the delivery server 1002 may deliver an entire multiplexed stream to a terminal device.

In the example of FIG. 19, the delivery server 1002 reads the stream data 1011 from the stream storage device 1001. Then, the delivery server 1002 delivers the stream data 1011 directly to the PC 1004 having high processing capabilities. Because the AV device 1005 has low processing capabilities, the delivery server 1002 generates stream data 1012 containing only an encoded stream of the base layer extracted from the stream data 1011 and delivers the stream data 1012 to the AV device 1005. The delivery server 1002 delivers the stream data 1011 directly to the tablet device 1006 capable of communication at a high communication rate. Because the mobile phone 1007 can communicate at a low communication rate, the delivery server 1002 delivers the stream data 1012 containing only an encoded stream of the base layer to the mobile phone 1007.

By using the multiplexed stream in this manner, the amount of traffic to be transmitted can adaptively be adjusted. The code amount of the stream data 1011 is reduced when compared with a case when each layer is individually encoded and thus, even if the whole stream data 1011 is delivered, the load on the network 1003 can be lessened. Further, memory resources of the stream storage device 1001 are saved.

Hardware performance of the terminal devices is different from device to device. In addition, capabilities of applications run on the terminal devices are diverse. Further, communication capacities of the network 1003 are varied. Capacities available for data transmission may change every moment due to other traffic. Thus, before starting delivery of stream data, the delivery server 1002 may acquire terminal information about hardware performance and application capabilities of terminal devices and network information about communication capacities of the network 1003 through signaling with the delivery destination terminal device. Then, the delivery server 1002 can select the stream to be delivered based on the acquired information.

Incidentally, the layer to be decoded may be extracted by the terminal device. For example, the PC 1004 may display a base layer image extracted and decoded from a received multiplexed stream on the screen thereof. After generating the stream data 1012 by extracting an encoded stream of the base layer from a received multiplexed stream, the PC 1004 may cause a storage medium to store the stream data 1012 or transfer the stream data to another device.

The configuration of the data transmission system 1000 shown in FIG. 19 is only an example. The data transmission system 1000 may include any numbers of the stream storage device 1001, the delivery server 1002, the network 1003, and terminal devices.

### (2) Second Example

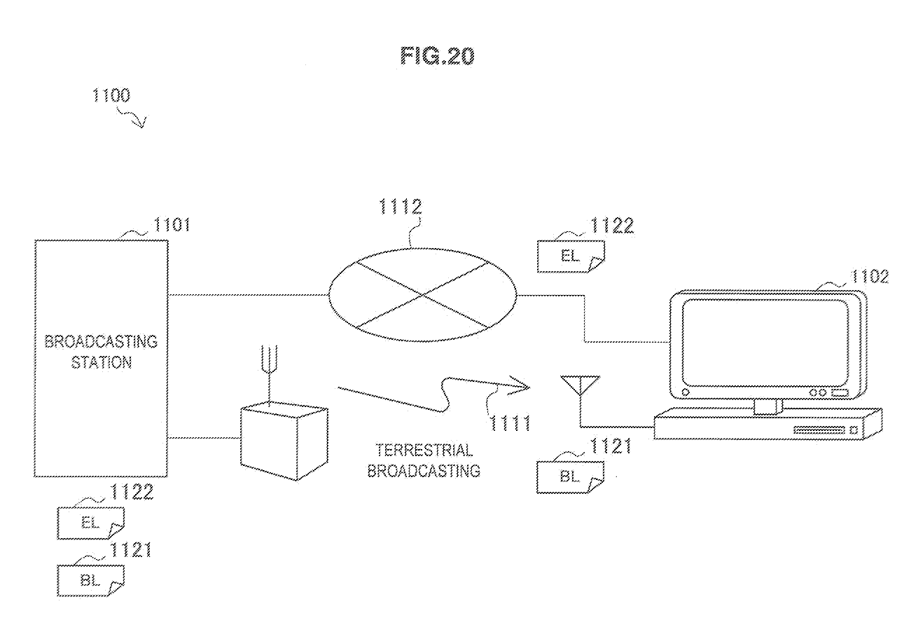

In the second example, scalable video coding is used for transmission of data via a plurality of communication channels. Referring to FIG. 20, a data transmission system 1100 includes a broadcasting station 1101 and a terminal device 1102. The broadcasting station 1101 broadcasts an encoded stream 1121 of the base layer on a terrestrial channel 1111. The broadcasting station 1101 also broadcasts an encoded stream 1122 of an enhancement layer to the terminal device 1102 via a network 1112.

The terminal device 1102 has a receiving function to receive terrestrial broadcasting broadcast by the broadcasting station 1101 and receives the encoded stream 1121 of the base layer via the terrestrial channel 1111. The terminal device 1102 also has a communication function to communicate with the broadcasting station 1101 and receives the encoded stream 1122 of an enhancement layer via the network 1112.

After receiving the encoded stream 1121 of the base layer, for example, in response to user's instructions, the terminal device 1102 may decode a base layer image from the received encoded stream 1121 and display the base layer image on the screen. Alternatively, the terminal device 1102 may cause a storage medium to store the decoded base layer image or transfer the base layer image to another device.

After receiving the encoded stream 1122 of an enhancement layer via the network 1112, for example, in response to user's instructions, the terminal device 1102 may generate a multiplexed stream by multiplexing the encoded stream 1121 of the base layer and the encoded stream 1122 of an enhancement layer. The terminal device 1102 may also decode an enhancement image from the encoded stream 1122 of an enhancement layer to display the enhancement image on the screen. Alternatively, the terminal device 1102 may cause a storage medium to store the decoded enhancement layer image or transfer the enhancement layer image to another device.

As described above, an encoded stream of each layer contained in a multiplexed stream can be transmitted via a different communication channel for each layer. Accordingly, a communication delay or an occurrence of overflow can be reduced by distributing loads on individual channels.

The communication channel to be used for transmission may dynamically be selected in accordance with some condition. For example, the encoded stream 1121 of the base layer whose data amount is relatively large may be transmitted via a communication channel having a wider bandwidth and the encoded stream 1122 of an enhancement layer whose data amount is relatively small may be transmitted via a communication channel having a narrower bandwidth. The communication channel on which the encoded stream 1122 of a specific layer is transmitted may be switched in accordance with the bandwidth of the communication channel. Accordingly, the load on individual channels can be lessened more effectively.

The configuration of the data transmission system 1100 shown in FIG. 20 is only an example. The data transmission system 1100 may include any numbers of communication channels and terminal devices. The configuration of the system described here may also be applied to other uses than broadcasting.

### (3) Third Example

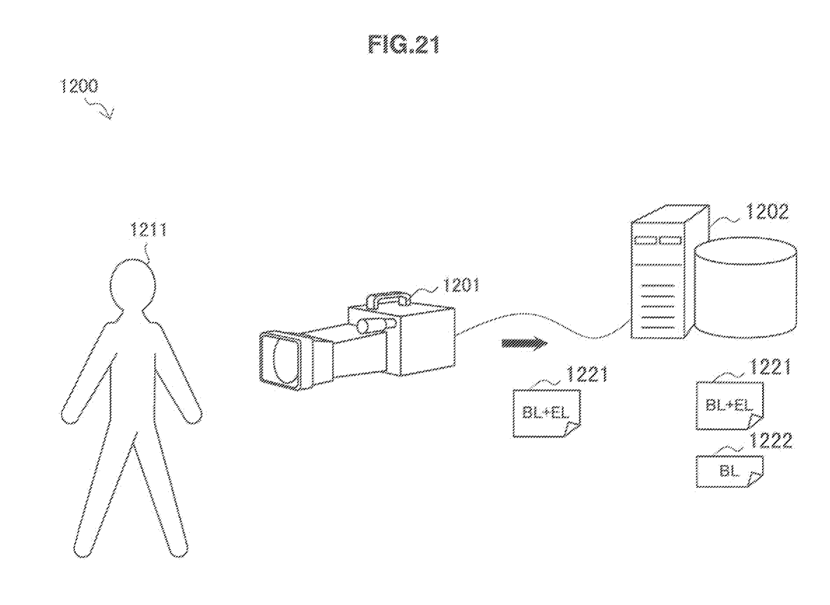

In the third example, scalable video coding is used for storage of video. Referring to FIG. 21, a data transmission system 1200 includes an imaging device 1201 and a stream storage device 1202. The imaging device 1201 scalable-encodes image data generated by a subject 1211 being imaged to generate a multiplexed stream 1221. The multiplexed stream 1221 includes an encoded stream of the base layer and an encoded stream of an enhancement layer. Then, the imaging device 1201 supplies the multiplexed stream 1221 to the stream storage device 1202.

The stream storage device 1202 stores the multiplexed stream 1221 supplied from the imaging device 1201 in different image quality for each mode. For example, the stream storage device 1202 extracts the encoded stream 1222 of the base layer from the multiplexed stream 1221 in normal mode and stores the extracted encoded stream 1222 of the base layer. In high quality mode, by contrast, the stream storage device 1202 stores the multiplexed stream 1221 as it is. Accordingly, the stream storage device 1202 can store a high-quality stream with a large amount of data only when recording of video in high quality is desired. Therefore, memory resources can be saved while the influence of image degradation on users is curbed.

For example, the imaging device 1201 is assumed to be a surveillance camera. When no surveillance object (for example, no intruder) appears in a captured image, the normal mode is selected. In this case, the captured image is likely to be unimportant and priority is given to the reduction of the amount of data so that the video is recorded in low image quality (that is, only the encoded stream 1222 of the base layer is stored). In contract, when a surveillance object (for example, the subject 1211 as an intruder) appears in a captured image, the high-quality mode is selected. In this case, the captured image is likely to be important and priority is given to high image quality so that the video is recorded in high image quality (that is, the multiplexed stream 1221 is stored).

In the example of FIG. 21, the mode is selected by the stream storage device 1202 based on, for example, an image analysis result. However, the present embodiment is not limited to such an example and the imaging device 1201 may select the mode. In the latter case, imaging device 1201 may supply the encoded stream 1222 of the base layer to the stream storage device 1202 in normal mode and the multiplexed stream 1221 to the stream storage device 1202 in high-quality mode.

Selection criteria for selecting the mode may be any criteria. For example, the mode may be switched in accordance with the loudness of voice acquired through a microphone or the waveform of voice. The mode may also be switched periodically. Also, the mode may be switched in response to user's instructions. Further, the number of selectable modes may be any number as long as the number of hierarchized layers is not exceeded.

The configuration of the data transmission system 1200 shown in FIG. 21 is only an example. The data transmission system 1200 may include any number of the imaging device 1201. The configuration of the system described here may also be applied to other uses than the surveillance camera.

### 6-3. Others

### (1) Application to the Multi-View Codec

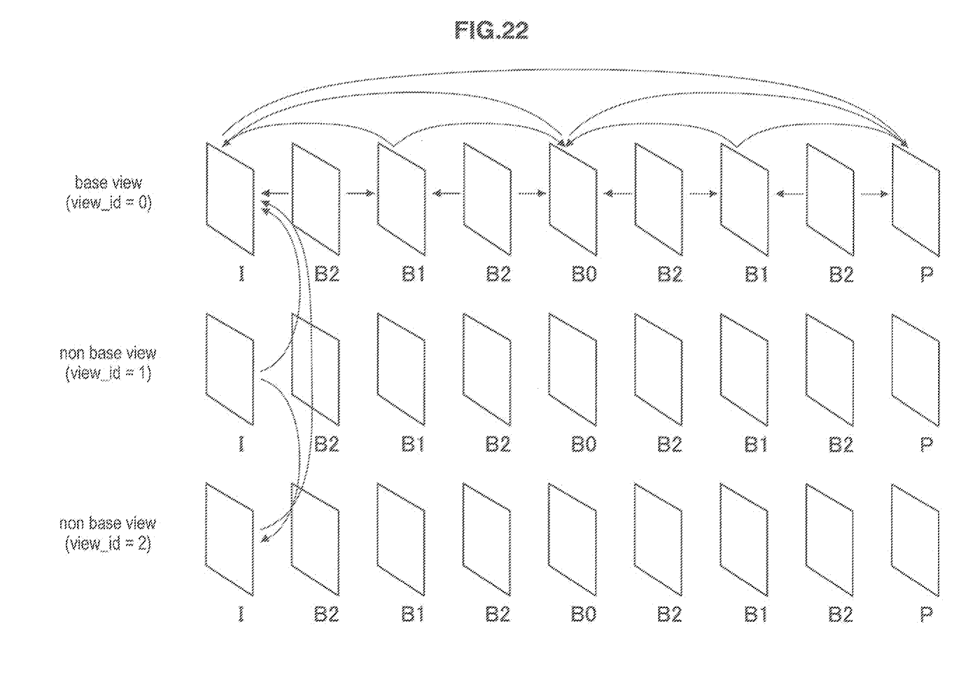

The multi-view codec is a kind of multi-layer codec and is an image encoding system to encode and decode so-called multi-view video. FIG. 22 is an explanatory view illustrating a multi-view codec. Referring to FIG. 22, sequences of three view frames captured from three viewpoints are shown. A view ID (view_id) is attached to each view. Among a plurality of these views, one view is specified as the base view. Views other than the base view are called non-base views. In the example of FIG. 22, the view whose view ID is “0” is the base view and two views whose view ID is “1” or “2” are non-base views. When these views are hierarchically encoded, each view may correspond to a layer. As indicated by arrows in FIG. 22, an image of a non-base view is encoded and decoded by referring to an image of the base view (an image of the other non-base view may also be referred to).

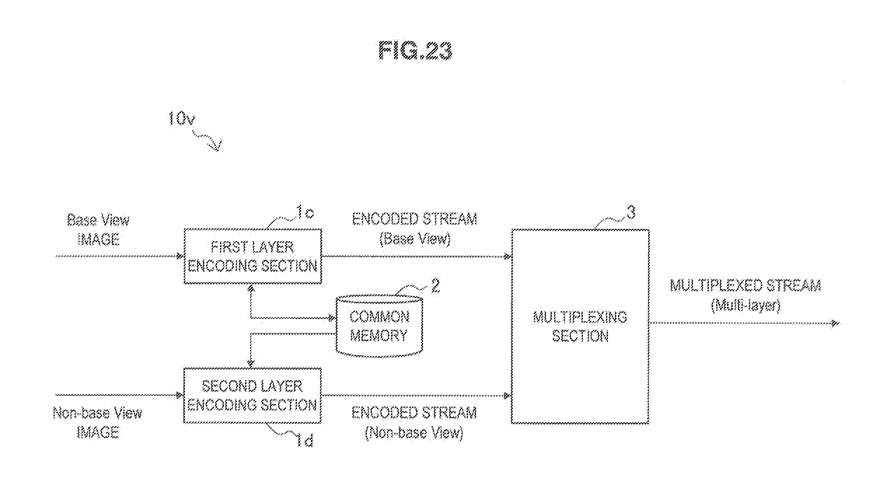

FIG. 23 is a block diagram showing a schematic configuration of an image encoding device 10v supporting the multi-view codec. Referring to FIG. 23, the image encoding device 10v includes a first layer encoding section 1c, a second layer encoding section 1d, the common memory 2, and the multiplexing section 3.

The function of the first layer encoding section 1c is the same as that of the first encoding section 1a described using FIG. 4 except that, instead of a base layer image, a base view image is received as input. The first layer encoding section 1c encodes the base view image to generate an encoded stream of a first layer. The function of the second layer encoding section 1d is the same as that of the second encoding section 1b described using FIG. 4 except that, instead of an enhancement layer image, a non-base view image is received as input. The second layer encoding section 1d encodes the non-base view image to generate an encoded stream of a second layer. The common memory 2 stores information commonly used between layers. The multiplexing section 3 multiplexes an encoded stream of the first layer generated by the first layer encoding section 1c and an encoded stream of the second layer generated by the second layer encoding section 1d to generate a multilayer multiplexed stream.

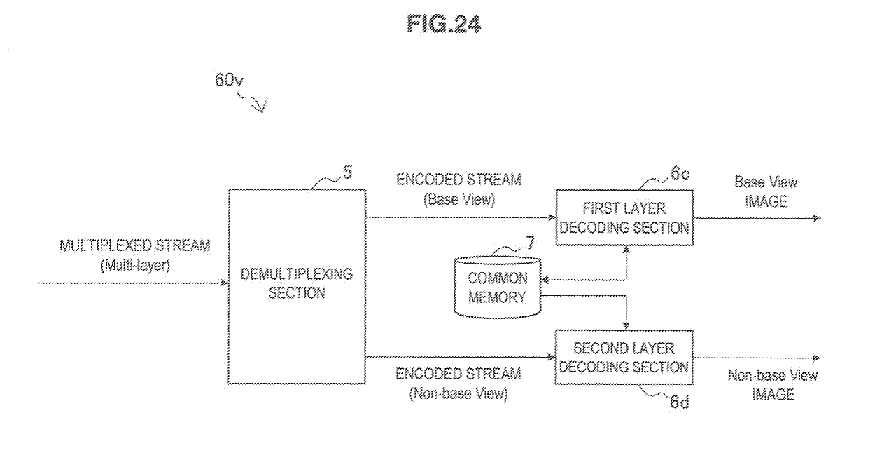

FIG. 24 is a block diagram showing a schematic configuration of an image decoding device 60v supporting the multi-view codec. Referring to FIG. 24, the image decoding device 60v includes the demultiplexing section 5, a first layer decoding section 6c, a second layer decoding section 6d, and the common memory 7.

The demultiplexing section 5 demultiplexes a multilayer multiplexed stream into an encoded stream of the first layer and an encoded stream of the second layer. The function of the first layer decoding section 6c is the same as that of the first decoding section 6a described using FIG. 5 except that an encoded stream in which, instead of a base layer image, a base view image is encoded is received as input. The first layer decoding section 6c decodes a base view image from an encoded stream of the first layer. The function of the second layer decoding section 6d is the same as that of the second decoding section 6b described using FIG. 5 except that an encoded stream in which, instead of an enhancement layer image, a non-base view image is encoded is received as input. The second layer decoding section 6d decodes a non-base view image from an encoded stream of the second layer. The common memory 7 stores information commonly used between layers.

When multi-view image data is encoded or decoded, a predicted image of the prediction block of the color difference component of a non-base view may be generated in LM mode using prediction function constructed based on reference pixels in the corresponding position of the base view according to the technology in the present disclosure. Accordingly, in the multi-view codec, like the case of scalable video coding, the prediction precision can be improved and coding efficiency can further be increased.

### (2) Application to Streaming Technology

Technology in the present disclosure may also be applied to a streaming protocol. In MPEG-DASH (Dynamic Adaptive Streaming over HTTP), for example, a plurality of encoded streams having mutually different parameters such as the resolution is prepared by a stream server in advance. Then, the streaming server dynamically selects appropriate data for streaming from the plurality of encoded streams and delivers the selected data. In such a streaming protocol, the prediction accuracy of an LD mode can be further increased according to technology in the present disclosure.

### 7. SUMMARY

Heretofore, the image encoding device 10 and the image decoding device 60 according to an embodiment have been described using FIGS. 1 to 24. According to the aforementioned embodiment, when a predicted image of the prediction block of the color difference component in an enhancement layer of an image subjected to scalable video coding or decoding is generated, a prediction function constructed based on, instead of reference pixels in neighboring blocks, reference pixels in the corresponding position in the base layer is used in LM mode. Therefore, even if correlations between color components are not similar between the prediction block and neighboring blocks, the prediction precision in LM mode can be improved by constructing a prediction function having good prediction precision.

Also according to the aforementioned embodiment, even if a prediction mode other than the LM mode is specified for the corresponding block in the base layer, the LM mode can be specified for the prediction block in the enhancement layer. That is, the LM mode can be utilized in the enhancement layer by overturning the prediction mode in the base layer. Accordingly, coding efficiency can be increased by utilizing the modified LM mode having high prediction precision in more image areas. Such a technique is useful in being able to increase the range of utilizing the LM mode in, for example, so-called multi-codec scalable video coding in which the base layer is encoded and decoded by an image coding scheme (for example. MPEG2 or AVC) that does not support the LM mode and an enhancement layer is encoded and decoded by an image coding scheme (for example, HEVC) that supports the LM mode.

Also according to the aforementioned embodiment, when the LM mode is specified for the corresponding block in the base layer, the LM mode can be specified for the prediction block in an enhancement layer without estimating other prediction modes. Accordingly, it becomes unnecessary to encode separate prediction mode information in the enhancement layer so that coding efficiency can further be increased. In addition, the processing cost on the encoder side can be reduced.

Mainly described herein is the example where the various pieces of information such as the information related to intra prediction and the information related to inter prediction are multiplexed to the header of the encoded stream and transmitted from the encoding side to the decoding side. The method of transmitting these pieces of information however is not limited to such example. For example, these pieces of information may be transmitted or recorded as separate data associated with the encoded bit stream without being multiplexed to the encoded bit stream. Here, the term “association” means to allow the image included in the bit stream (may be a part of the image such as a slice or a block) and the information corresponding to the current image to establish a link when decoding. Namely, the information may be transmitted on a different transmission path from the image (or the bit stream). The information may also be recorded in a different recording medium (or a different recording area in the same recording medium) from the image (or the bit stream). Furthermore, the information and the image (or the bit stream) may be associated with each other by an arbitrary unit such as a plurality of frames, one frame, or a portion within a frame.

The preferred embodiments of the present disclosure have been described above with reference to the accompanying drawings, whilst the present disclosure is not limited to the above examples, of course. A person skilled in the art may find various alternations and modifications within the scope of the appended claims, and it should be understood that they will naturally come under the technical scope of the present disclosure.

Additionally, the present technology may also be configured as below.

(1)

An image processing apparatus including:

an enhancement layer prediction section configured to generate a predicted image of a first prediction block of a color difference component in an enhancement layer of an image subjected to scalable video decoding using a prediction function of a luminance based color difference prediction mode having coefficients calculated from a luminance component and the color difference component in a position corresponding to the first prediction block in a base layer.

(2)

The image processing apparatus according to (1), wherein, when a prediction mode other than the luminance based color difference prediction mode is specified for a second prediction block in the base layer corresponding to the first prediction block, the enhancement layer prediction section generates the predicted image of the second prediction block using the prediction function having the coefficients when separate prediction mode information acquired for the first prediction block indicates the luminance based color difference prediction mode.

(3)

The image processing apparatus according to (1) or (2), further including:

a base layer decoding section configured to decode an encoded stream of the base layer according to a first encoding scheme that does not support the luminance based color difference prediction mode; and

an enhancement layer decoding section configured to decode the encoded stream of the enhancement layer according to a second encoding scheme that supports the luminance based color difference prediction mode.

(4)

The image processing apparatus according to (1), wherein, when the luminance based color difference prediction mode is specified for a second prediction block in the base layer corresponding to the first prediction block, the enhancement layer prediction section generates the predicted image of the second prediction block using the prediction function having the coefficients.

(5)

The image processing apparatus according to any one of (1) to (4), wherein the enhancement layer prediction section calculates the coefficients by substituting only a portion of the luminance component and the color difference component in a position corresponding to the first prediction block in the base layer into coefficient calculation formula of the luminance based color difference prediction mode.

(6)

The image processing apparatus according to any one of (1) to (5), further including:

a memory configured to store pixel values of the luminance component and the color difference component in the base layer before a deblocking filter being applied,

wherein the enhancement layer prediction section calculates the coefficients using the pixel values stored in the memory.

(7)

An image processing method including:

generating a predicted image of a first prediction block of a color difference component in an enhancement layer of an image subjected to scalable video decoding using a prediction function of a luminance based color difference prediction mode having coefficients calculated from a luminance component and the color difference component in a position corresponding to the first prediction block in a base layer.

(8)

An image processing apparatus including:

an enhancement layer prediction section configured to generate a predicted image of a first prediction block of a color difference component in an enhancement layer of an image subjected to scalable video coding using a prediction function of a luminance based color difference prediction mode having coefficients calculated from a luminance component and the color difference component in a position corresponding to the first prediction block in a base layer.

(9)

The image processing apparatus according to (8), wherein the enhancement layer prediction section selects, regardless of whether a luminance based color difference prediction mode is selected as an optimum prediction mode for a second prediction block in the base layer corresponding to the first prediction block, the optimum prediction mode for the second prediction block from one or more prediction modes including the luminance based color difference prediction mode using the prediction function having the coefficients.

(10)

The image processing apparatus according to (8) or (9), further including:

a base layer encoding section configured to encode an encoded stream of the base layer according to a first encoding scheme that does not support the luminance based color difference prediction mode; and

an enhancement layer encoding section configured to encode the encoded stream of the enhancement layer according to a second encoding scheme that supports the luminance based color difference prediction mode.

(11)

The image processing apparatus according to (8), wherein the enhancement layer prediction section selects, when a luminance based color difference prediction mode is selected as an optimum prediction mode for a second prediction block in the base layer corresponding to the first prediction block, the luminance based color difference prediction mode using the prediction function having the coefficients as the optimum prediction mode for the second prediction block.

(12)

The image processing apparatus according to any one of (8) to (11), wherein the enhancement layer prediction section calculates the coefficients by substituting only a portion of the luminance component and the color difference component in a position corresponding to the first prediction block in the base layer into coefficient calculation formula of the luminance based color difference prediction mode.

(13)

The image processing apparatus according to any one of (8) to (12), further including:

a memory configured to store pixel values of the luminance component and the color difference component before a filter being applied,

wherein the enhancement layer prediction section calculates the coefficients using the pixel values stored in the memory.

(14)

An image processing method including:

generating a predicted image of a first prediction block of a color difference component in an enhancement layer of an image subjected to scalable video coding using a prediction function of a luminance based color difference prediction mode having coefficients calculated from a luminance component and the color difference component in a position corresponding to the first prediction block in a base layer.

### REFERENCE SIGNS LIST

10 image encoding device (image processing apparatus)
40a intra prediction section (base layer prediction section)
40b intra prediction section (enhancement layer prediction section)
60 image decoding device (image processing apparatus)
90a intra prediction section (base layer prediction section)
90b intra prediction section (enhancement layer prediction section)

1. An image processing apparatus comprising:
an enhancement layer prediction section configured to generate a predicted image of a first prediction block of a color difference component in an enhancement layer of an image subjected to scalable video decoding using a prediction function of a luminance based color difference prediction mode having coefficients calculated from a luminance component and the color difference component in a position corresponding to the first prediction block in a base layer.

2. The image processing apparatus according to claim 1, wherein, when a prediction mode other than the luminance based color difference prediction mode is specified for a second prediction block in the base layer corresponding to the first prediction block, the enhancement layer prediction section generates the predicted image of the second prediction block using the prediction function having the coefficients when separate prediction mode information acquired for the first prediction block indicates the luminance based color difference prediction mode.

3. The image processing apparatus according to claim 1, further comprising:
a base layer decoding section configured to decode an encoded stream of the base layer according to a first encoding scheme that does not support the luminance based color difference prediction mode; and
an enhancement layer decoding section configured to decode the encoded stream of the enhancement layer according to a second encoding scheme that supports the luminance based color difference prediction mode.

4. The image processing apparatus according to claim 1, wherein, when the luminance based color difference prediction mode is specified for a second prediction block in the base layer corresponding to the first prediction block, the enhancement layer prediction section generates the predicted image of the second prediction block using the prediction function having the coefficients.

5. The image processing apparatus according to claim 1, wherein the enhancement layer prediction section calculates the coefficients by substituting only a portion of the luminance component and the color difference component in a position corresponding to the first prediction block in the base layer into coefficient calculation formula of the luminance based color difference prediction mode.

6. The image processing apparatus according to claim 1, further comprising:
a memory configured to store pixel values of the luminance component and the color difference component in the base layer before a deblocking filter being applied,
wherein the enhancement layer prediction section calculates the coefficients using the pixel values stored in the memory.

7. An image processing method comprising:
generating a predicted image of a first prediction block of a color difference component in an enhancement layer of an image subjected to scalable video decoding using a prediction function of a luminance based color difference prediction mode having coefficients calculated from a luminance component and the color difference component in a position corresponding to the first prediction block in a base layer.

8. An image processing apparatus comprising:
an enhancement layer prediction section configured to generate a predicted image of a first prediction block of a color difference component in an enhancement layer of an image subjected to scalable video coding using a prediction function of a luminance based color difference prediction mode having coefficients calculated from a luminance component and the color difference component in a position corresponding to the first prediction block in a base layer.

9. The image processing apparatus according to claim 8, wherein the enhancement layer prediction section selects, regardless of whether a luminance based color difference prediction mode is selected as an optimum prediction mode for a second prediction block in the base layer corresponding to the first prediction block, the optimum prediction mode for the second prediction block from one or more prediction modes including the luminance based color difference prediction mode using the prediction function having the coefficients.

10. The image processing apparatus according to claim 8, further comprising:
a base layer encoding section configured to encode an encoded stream of the base layer according to a first encoding scheme that does not support the luminance based color difference prediction mode; and
an enhancement layer encoding section configured to encode the encoded stream of the enhancement layer according to a second encoding scheme that supports the luminance based color difference prediction mode.

11. The image processing apparatus according to claim 8, wherein the enhancement layer prediction section selects, when a luminance based color difference prediction mode is selected as an optimum prediction mode for a second prediction block in the base layer corresponding to the first prediction block, the luminance based color difference prediction mode using the prediction function having the coefficients as the optimum prediction mode for the second prediction block.

12. The image processing apparatus according to claim 8, wherein the enhancement layer prediction section calculates the coefficients by substituting only a portion of the luminance component and the color difference component in a position corresponding to the first prediction block in the base layer into coefficient calculation formula of the luminance based color difference prediction mode.

13. The image processing apparatus according to claim 8, further comprising:
a memory configured to store pixel values of the luminance component and the color difference component before a filter being applied,
wherein the enhancement layer prediction section calculates the coefficients using the pixel values stored in the memory.

14. An image processing method comprising:
generating a predicted image of a first prediction block of a color difference component in an enhancement layer of an image subjected to scalable video coding using a prediction function of a luminance based color difference prediction mode having coefficients calculated from a luminance component and the color difference component in a position corresponding to the first prediction block in a base layer.
